(19) United States
(12) Patent Application Publication
(10) Pub. No.: US 2026/0177974 A1
(43) Pub. Date: Jun. 25, 2026

(54) CARTRIDGE UNIT AND IMAGE FORMING APPARATUS

(71) Applicant: CANON KABUSHIKI KAISHA, Tokyo (JP)

(72) Inventors: RYUTA MURAKAMI, Shizuoka (JP); NORIYUKI KOMATSU, Shizuoka (JP)

(21) Appl. No.: 19/411,567

(22) Filed: Dec. 8, 2025

(30) Foreign Application Priority Data
Dec. 19, 2024 (JP) 2024-224569

(51) Int. Cl. G03G 21/18

(52) U.S. Cl. CPC G03G 21/1825; G03G 21/1814; G03G 21/1864; G03G 21/1878; G03G 2221/1869

(57) ABSTRACT

A cartridge unit configured to be detachably attached to an apparatus body of an image forming apparatus includes a first unit including a photosensitive drum, a frame, a developing roller, and a driving-force transmission portion, and a second unit including a memory and a holder, the second unit being detachably attached to the first unit and configured to accommodate developer. The frame includes a bottom surface that extends in an axis direction, and a first side wall that extends from the bottom surface in an intersecting direction that intersects the axis direction, and that is positioned, in the axis direction, inside with respect to the driving-force transmission portion and outside with respect to the second unit attached to the first unit. The memory is disposed outside with respect to the first side wall in the axis direction when the second unit is attached to the first unit.

### BACKGROUND

### Field of the Technology

The present disclosure relates to a cartridge unit which can be detachably attached to an electrophotographic image forming apparatus, and an image forming apparatus to which the cartridge unit is attached.

### Description of the Related Art

A laser-beam printer or a copying machine that serves as an electrophotographic image forming apparatus forms an image on a sheet by forming a toner image on a photosensitive drum, and by transferring the toner image to the sheet that serves as a recording material. In such an image forming apparatus, some components of the image forming apparatus are disposed in a cartridge, and the maintenance or replacement work is performed by taking the cartridge out of the apparatus body. The method is widely used for making it easy to perform the maintenance. For example, Japanese Patent Application Publication No. 2022-157973 describes a cartridge unit that can be detachably attached to an apparatus body, and that includes a photosensitive member unit that includes a photosensitive drum, a developing unit that includes a developing roller, and a toner cartridge that stores toner.

In the cartridge unit, the developing unit and the toner cartridge can be detachably attached to the photosensitive member unit. In addition, in the cartridge unit, the toner cartridge that stores toner can be detachably attached to a process cartridge that includes the developing unit and the photosensitive member unit. Thus, in the cartridge unit, the process cartridge and the toner cartridge are integrated with each other. In addition, in the cartridge unit, the toner cartridge includes a memory. The memory is held by a holder unit so as to be able to move with respect to a toner casing.

However, in the cartridge unit described in Japanese Patent Application Publication No. 2022-157973, the memory overlaps with a side wall of the photosensitive member unit in a plan view. Thus, if the memory is disposed on the side on which a driving-force transmission portion that transmits the driving force to the developing roller in the developing unit is disposed, the holder unit and the driving-force transmission portion will interfere with each other. For preventing the interference, the apparatus may be upsized.

### SUMMARY

The present disclosure provides a cartridge unit and an image forming apparatus in which the memory can be disposed on the side, in the axis direction, on which the driving-force transmission portion for the developing roller is disposed, without upsizing the apparatus.

According to a first aspect of the present disclosure, a cartridge unit configured to be detachably attached to an apparatus body of an image forming apparatus includes a first unit including a photosensitive drum configured to bear a developer image, a frame rotatably supporting the photosensitive drum, a developing roller configured to develop an electrostatic latent image formed on a surface of the photosensitive drum, and including a first end in an axis direction and a second end opposite to the first end in the axis direction, and a driving-force transmission portion disposed on a side of the first end of the developing roller and configured to transmit driving force transmitted from the image forming apparatus, to the developing roller, and a second unit including a memory disposed on the side of the first end and configured to store information, and a holder holding the memory, the second unit being detachably attached to the first unit and configured to accommodate developer. The frame includes a bottom surface that extends in the axis direction, and a first side wall that extends from the bottom surface in an intersecting direction that intersects the axis direction, and that is positioned, in the axis direction, inside with respect to the driving-force transmission portion and outside with respect to the second unit attached to the first unit. The memory is disposed outside with respect to the first side wall in the axis direction in a state where the second unit is attached to the first unit.

According to a second aspect of the present disclosure, an image forming apparatus includes the cartridge unit and attached to the apparatus body, and a fixing apparatus configured to fix a developer image formed on a recording material to the recording material.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a cartridge unit of a first embodiment.

FIG. 2 is a cross-sectional view of an image forming apparatus of the first embodiment.

FIG. 3 is a cross-sectional view of a process cartridge of the first embodiment.

FIG. 4 is a cross-sectional view of a developing unit of the first embodiment.

FIG. 5 is a perspective view of the developing unit of the first embodiment.

FIG. 6 is an exploded perspective view of the developing unit of the first embodiment.

FIG. 7 is a plan view of the developing unit of the first embodiment.

FIG. 8 is a perspective view of the developing unit of the first embodiment.

FIG. 9 is a perspective view of the process cartridge of the first embodiment.

FIG. 10 is a partial perspective view of a photosensitive member unit of the first embodiment.

FIG. 11A is a perspective view that illustrates the photosensitive member unit and the developing unit of the first embodiment, and that is viewed from above.

FIG. 11B is a perspective view that illustrates the photosensitive member unit and the developing unit of the first embodiment, and that is viewed from below.

FIG. 12 is a plan view of the photosensitive member unit and the developing unit of the first embodiment.

FIG. 13 is an exploded perspective view in which a toner cartridge of the first embodiment is viewed from below.

FIG. 14 is a perspective view in which the toner cartridge of the first embodiment is viewed from below.

FIG. 15 is a cross-sectional view of the toner cartridge of the first embodiment.

FIG. 16A is a diagram that illustrates a process for attaching the toner cartridge to the process cartridge of the first embodiment, and that illustrates a state before the toner cartridge is attached to the process cartridge.

FIG. 16B is a diagram that illustrates the process for attaching the toner cartridge to the process cartridge of the first embodiment, and that illustrates a state where the toner cartridge is being attached to the process cartridge.

FIG. 16C is a diagram that illustrates the process for attaching the toner cartridge to the process cartridge of the first embodiment, and that illustrates a state after the toner cartridge is attached to the process cartridge.

FIG. 17 is a cross-sectional view of the cartridge unit of the first embodiment.

FIG. 18A is a diagram that illustrates an operation of a receive port in a process for attaching the toner cartridge of the first embodiment, and that illustrates a state where a receive shutter is closed.

FIG. 18B is a diagram that illustrates the operation of the receive port in the process for attaching the toner cartridge of the first embodiment, and that illustrates a state where the receive shutter is opened.

FIG. 19A is a diagram that illustrates an operation of a discharge port in the process for attaching the toner cartridge of the first embodiment, and that illustrates a state where a discharging shutter is closed.

FIG. 19B is a diagram that illustrates the operation of the discharge port in the process for attaching the toner cartridge of the first embodiment, and that illustrates a state where the discharging shutter is opened.

FIG. 20A is a diagram that illustrates an operation of a lift mechanism in the process for attaching the toner cartridge of the first embodiment, and that illustrates a state where the toner cartridge is put on the lift mechanism.

FIG. 20B is a diagram that illustrates the operation of the lift mechanism in the process for attaching the toner cartridge of the first embodiment, and that illustrates a state where the toner cartridge is opening the lift mechanism.

FIG. 20C is a diagram that illustrates the operation of the lift mechanism in the process for attaching the toner cartridge of the first embodiment, and that illustrates a state where the attachment of the toner cartridge is completed.

FIG. 21A is a diagram that illustrates an operation of the lift mechanism for changing the state of the toner cartridge of the first embodiment that is in an attachment state, to a lift-up state, and that illustrates a state where the attachment of the toner cartridge is completed.

FIG. 21B is a diagram that illustrates the operation of the lift mechanism for changing the state of the toner cartridge of the first embodiment that is in an attachment state, to the lift-up state, and that illustrates a state where the toner cartridge is being lifted up by the lift mechanism.

FIG. 21C is a diagram that illustrates the operation of the lift mechanism for changing the state of the toner cartridge of the first embodiment that is in an attachment state, to the lift-up state, and that illustrates a state where the toner cartridge has been lifted up.

FIG. 22 is an exploded perspective view of the toner cartridge of the first embodiment.

FIG. 23 is an exploded perspective view of a memory holder unit of the first embodiment.

FIG. 24A is a partial cross-sectional view of the image forming apparatus of the first embodiment that illustrates a state where the attachment of the toner cartridge is started.

FIG. 24B is a partial cross-sectional view of the image forming apparatus of the first embodiment that illustrates a state after the attachment of the toner cartridge is completed.

FIG. 25 is a partial perspective view of the interior of the apparatus body of the first embodiment.

FIG. 26 is a partial cross-sectional view of the cartridge unit of the first embodiment.

FIG. 27A is a side view of the cartridge unit of the first embodiment.

FIG. 27B is a side view illustrating a left support portion of the cartridge unit of the first embodiment.

FIG. 28A is a partial front view of the toner cartridge of the first embodiment.

FIG. 28B is a partial perspective view of the cartridge unit of the first embodiment.

FIG. 29 is an exploded perspective view of a toner cartridge of a second embodiment.

FIG. 30 is a perspective view of a memory holder unit of the second embodiment.

FIG. 31 is a diagram illustrating a process for attaching the toner cartridge of the second embodiment.

FIG. 32A is an exploded perspective view of a toner cartridge of a third embodiment.

FIG. 32B is a perspective view of a memory holder unit of the third embodiment.

FIG. 33 is a side view of a cartridge unit of the third embodiment.

FIG. 34 is an exploded perspective view of a developing unit of a fourth embodiment.

FIG. 35 is a cross-sectional view of a developing unit and a toner cartridge of the fourth embodiment.

FIG. 36 is an exploded perspective view of a toner cartridge of a modification of the first embodiment.

FIG. 37 is an exploded perspective view of a toner cartridge of another modification of the first embodiment.

FIG. 38 is an exploded perspective view of a toner cartridge of still another modification of the first embodiment.

### DESCRIPTION OF THE EMBODIMENTS

Hereinafter, some embodiments of the present disclosure will be described with reference to the accompanying drawings. In the present disclosure, the image forming apparatus is not limited to a single-function printer that has the printing function alone. That is, examples of the image forming apparatus widely include apparatuses that form images on recording materials. For example, the image forming apparatus may be a copying machine that has the copying function, a multi-function printer that has multiple functions, or a large-sized commercial printer.

### First Embodiment

A first embodiment of the present disclosure will be described in detail with reference to the accompanying drawings. In the following description, the direction of an image forming apparatus 1 is defined with respect to a user that uses the image forming apparatus 1. That is, the front-surface side of the image forming apparatus 1 is defined as a front side, the back-surface side is defined as a back side, the upper-surface side (top-surface side) is defined as an upper side, and the-lower surface side (bottom-surface side) is defined as a lower side. In addition, the left side of the image forming apparatus 1 viewed from the front-surface side is defined as a left side, and the right side of the image forming apparatus viewed from the front-surface side is defined as a right side. The direction of a process cartridge 5 and a toner cartridge 9 is defined similar to the direction of the image forming apparatus 1, because the process cartridge 5 and the toner cartridge 9 take the same posture as that of the image forming apparatus 1 in a state where the process cartridge 5 and the toner cartridge 9 are attached to the image forming apparatus 1.

A direction in each of the drawings is defined by a corresponding arrow illustrated in the drawing. A front-and-back direction, an up-and-down direction, and a right-and-left direction indicated by arrows are orthogonal to each other. Each of the above-described directions indicates the same direction in all the drawings. The up-and-down direction is parallel to the vertical direction, and the right-and-left direction and the front-and-back direction are parallel to the horizontal direction. In addition, the right-and-left direction is parallel to each of the rotation-axis direction of a photosensitive drum 61 and the rotation-axis direction of a developing roller 71. In addition, in the present embodiment, the right-and-left direction is expressed as an axis direction Da, the front-and-back direction is expressed as an insertion-and-drawing direction Db, and the up-and-down direction is expressed as an up-and-down direction Dc.

In the present embodiment, a unit into which a developing unit 7 and a photosensitive member unit 6 are integrated with each other by attaching the developing unit 7 to the photosensitive member unit 6 is referred to as a process cartridge 5. An insertion direction (attachment direction) S1 in which the process cartridge 5 is attached to an apparatus body 2, and a detachment direction S2 are parallel to the front-and-back direction (i.e., the insertion-and-drawing direction Db), and orthogonal to the right-and-left direction (i.e., the axis direction Da) and the up-and-down direction Dc. In addition, a toner cartridge 9 that is one example of a second unit that supplies toner to the developing unit 7 is detachably attached to the process cartridge 5 that is one example of a first unit. A unit into which the process cartridge 5 and the toner cartridge 9 are integrated with each other by attaching the toner cartridge 9 to the process cartridge 5 is referred to as a cartridge unit 10.

### Overall Configuration of Image Forming Apparatus

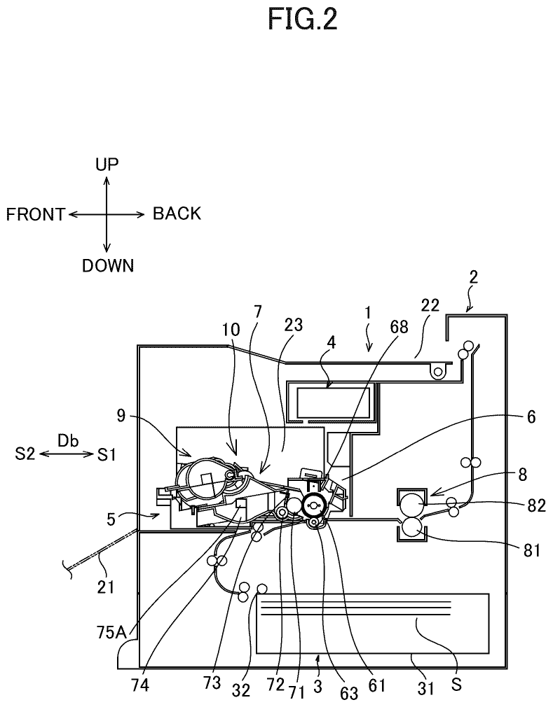

FIG. 2 is a cross-sectional view of the image forming apparatus 1. The cartridge unit 10 is detachably attached to the apparatus body 2 of the image forming apparatus 1. The image forming apparatus 1 performs an image forming operation that forms an image on a sheet S that is a recording material, in accordance with image information sent from an external apparatus such as a personal computer. The sheet S may be any one of a variety of sheets with different sizes and materials. For example, the sheet S may be a paper sheet, such as a regular paper sheet or a thick paper sheet, a sheet material, such as a coated paper sheet, on which certain surface treatment has been performed, a specially-shaped sheet material, such as an envelope or an index paper sheet, a plastic film, or a cloth sheet. As illustrated in FIG. 2, the image forming apparatus 1 includes a feeding portion 3 that supplies the sheet S into the apparatus body 2, an exposure apparatus 4, the cartridge unit 10 that transfers a toner image (i.e., a developer image) onto the sheet S, and a fixing apparatus 8 that thermally fixes the toner image transferred onto the sheet S, to the sheet S.

The feeding portion 3 is disposed in a lower portion of the apparatus body 2, and includes a feeding tray 31 and a feeding mechanism 32. The sheet S accommodated in the feeding tray 31 is supplied toward between the photosensitive drum 61 and a transfer roller 63 of the cartridge unit 10 by the feeding mechanism 32.

The exposure apparatus 4 is disposed in an upper portion of the apparatus body 2, and includes a laser-beam emitting portion, a polygon mirror, a lens, and a reflecting mirror (the laser-beam emitting portion, the polygon mirror, the lens, and the reflecting mirror are not illustrated). The exposure apparatus 4 causes a laser-beam emitting portion to emit a laser beam in accordance with image data, and the surface of the photosensitive drum 61 is scanned with the laser beam at a high speed, so that the surface of the photosensitive drum 61 is exposed.

The cartridge unit 10 is disposed below the exposure apparatus 4. When a door 21 disposed in a front portion of the apparatus body 2 is opened (as illustrated by a dot-dot-dash line in FIG. 2), an opening is formed in the apparatus body 2. The cartridge unit 10 is inserted into a storage portion 23 of the apparatus body 2 through the opening in the insertion direction S1, and attached to the apparatus body 2. For detaching the cartridge unit 10 from the apparatus body 2, the cartridge unit 10 is moved in the detachment direction S2 and detached from the apparatus body 2.

The photosensitive member unit 6 includes the photosensitive drum 61 that bears a developer image, a corona charger 68, and the transfer roller 63. The developing unit 7 is detachably attached to the photosensitive member unit 6. However, the developing unit 7 may be integrated with the photosensitive member unit 6 such that the developing unit 7 cannot be detached from the photosensitive member unit 6. In this case, the unit into which the developing unit 7 and the photosensitive member unit 6 are integrated with each other is replaced with another unit. The developing unit 7 includes the developing roller 71, a supplying roller 72, a layer-thickness regulation blade 73, a toner storage portion (developer storage portion) 74 that accommodates or stores toner (developer), a first agitator 75A disposed in the toner storage portion 74, and a driving-force transmission portion 716.

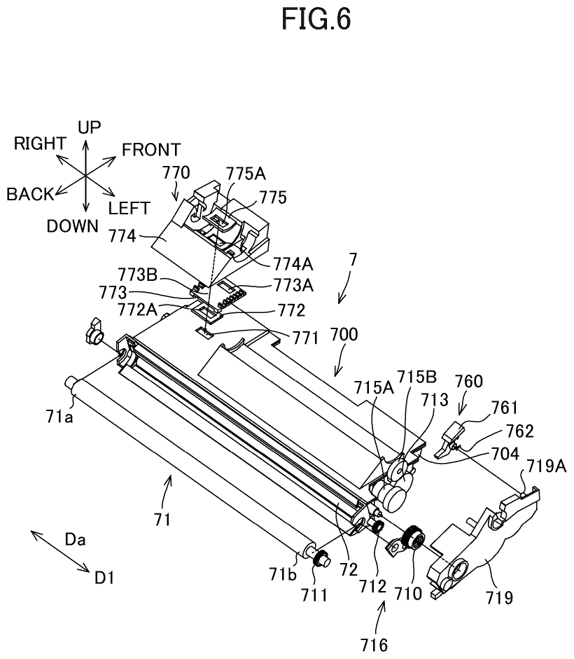

As illustrated in FIG. 6, the developing roller 71 develops an electrostatic latent image formed on the surface of the photosensitive drum 61, and includes a first end 71a formed in the axis direction and a second end 71b opposite to the first end 71a. The direction that extends from the first end 71a toward the second end 71b in the axis direction Da is referred to as a first direction D1.

### Image Forming Process

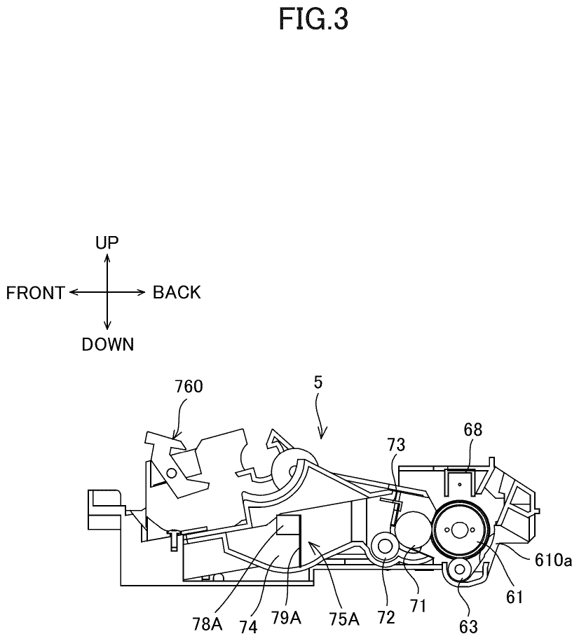

Next, an image forming process performed by using the process cartridge 5 will be described. FIG. 3 is a cross-sectional view of the process cartridge 5. The photosensitive drum 61 is being rotated in the image forming process. The corona charger 68 is not in contact with the surface of the photosensitive drum 61, and in this state, charges the surface of the photosensitive drum 61. First, the surface of the photosensitive drum 61 is uniformly charged by the corona charger 68, and then, the surface of the photosensitive drum 61 is exposed by the laser beam emitted from the exposure apparatus 4 (see FIG. 2) in accordance with the image data. In this manner, the electrostatic latent image is formed on the photosensitive drum 61 in accordance with the image data.

On the other hand, the toner stored in the toner storage portion 74 is agitated by the first agitator 75A, and then is supplied to the developing roller 71 via the supplying roller 72. The toner supplied to the developing roller 71 enters a space between the developing roller 71 and the layer-thickness regulation blade 73, and is borne on the developing roller 71 as a thin layer that has a constant thickness.

The toner borne on developing roller 71 is supplied to the electrostatic latent image formed on the photosensitive drum 61. With this operation, the toner adheres to the electrostatic latent image and the electrostatic latent image is visualized, so that a toner image is formed on the photosensitive drum 61. After that, the sheet S is conveyed to between the photosensitive drum 61 and the transfer roller 63, so that the toner image formed on the photosensitive drum 61 is transferred onto the sheet S. The sheet S is discharged from the process cartridge 5 through an opening 610a formed in a frame 610.

As illustrated in FIG. 2, the fixing apparatus 8 is disposed behind the process cartridge 5, and includes a heating roller 82 and a pressing roller 81. The sheet S onto which the toner image has been transferred passes through the fixing apparatus 8. When the sheet S passes through the fixing apparatus 8, the sheet S is heated and pressed by the heating roller 82 and the pressing roller 81, so that the toner image is fixed onto the sheet S. The sheet S that has passed through the fixing apparatus 8 is discharged onto a discharging tray 22.

### Configuration of Process Cartridge

Next, each unit of the process cartridge 5 will be described. The process cartridge 5 includes the photosensitive member unit 6 and the developing unit 7.

### Configuration of Developing Unit

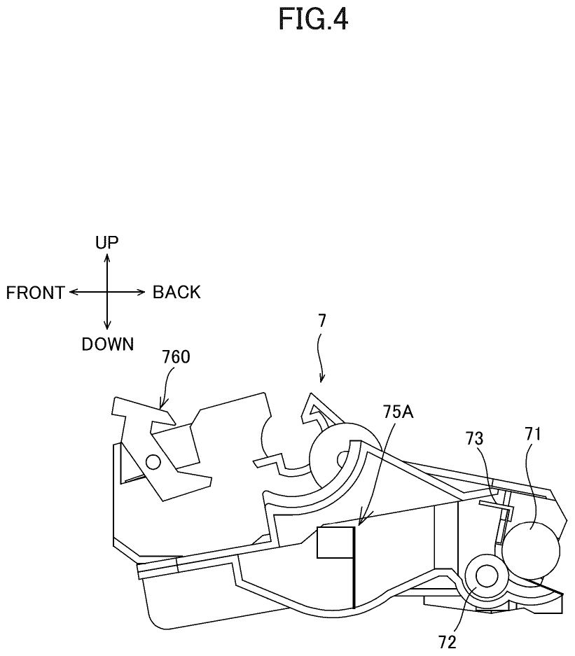

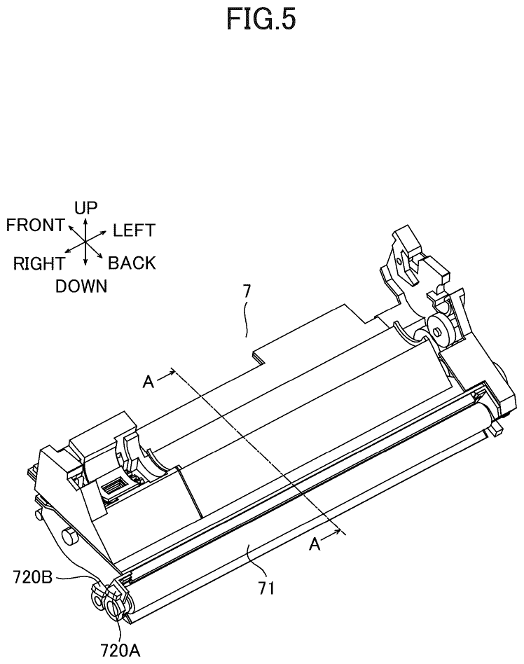

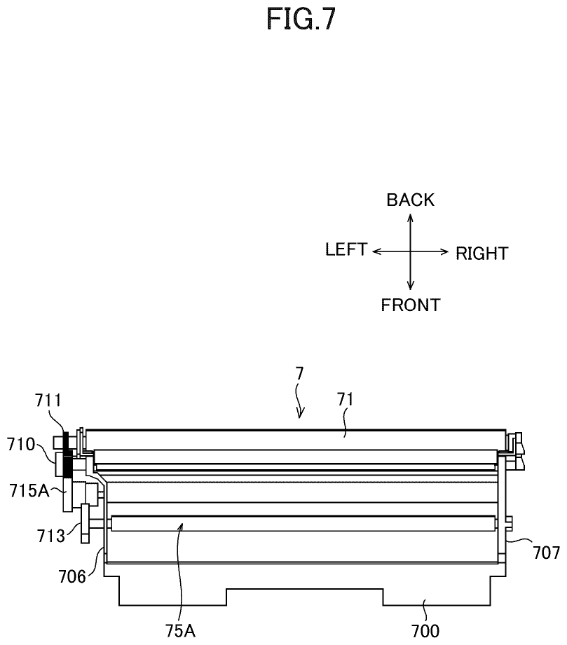

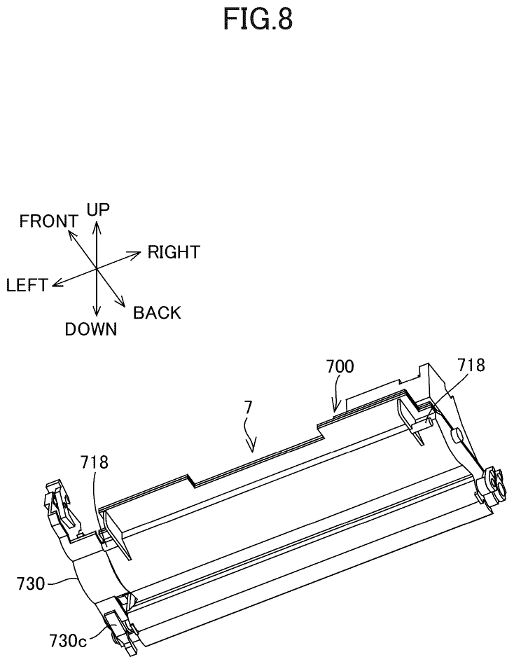

First, a configuration of the developing unit 7 will be described. FIG. 4 is a cross-sectional view of the developing unit 7, taken along a A-A section illustrated in FIG. 5. Note that the A-A section is parallel to the up-and-down direction and the front-and-back direction. FIG. 5 is a perspective view of the developing unit 7. FIG. 6 is an exploded perspective view of the developing unit 7. FIG. 7 is a plan view of the developing unit 7. In FIG. 7, the top surface of a casing 700 is removed for convenience of description. FIG. 8 is a perspective view in which the developing unit 7 is viewed from below.

As illustrated in FIG. 4, the developing roller 71 is rotatably supported by a back portion of the developing unit 7. Hereinafter, the rotation-axis direction of the developing roller 71 in the configuration of the developing unit 7 is referred to as the axis direction Da. As illustrated in FIGS. 6 and 7, both ends of each of the developing roller 71, the supplying roller 72, and the first agitator 75A are rotatably supported by a left side wall 706 and a right side wall 707 of the casing 700. In addition, the driving-force transmission portion 716 is disposed on the left side of left side wall 706 of the casing 700. The driving-force transmission portion 716 is disposed downstream of the developing roller 71 in the first direction D1. That is, the driving-force transmission portion 716 is disposed downstream of the roller portion of the developing roller 71 in the first direction D1. The driving-force transmission portion 716 transmits the driving force transmitted from the image forming apparatus 1, to the developing roller 71. The driving-force transmission portion 716 includes a developing coupling 710, a developing roller gear 711, a supplying roller gear 712, a first agitator gear 713, and idle gears 715A and 715B. The developing roller gear 711 is fixed to an end portion of the rotary shaft of the developing roller 71, and the supplying roller gear 712 is fixed to an end portion of the rotary shaft of the supplying roller 72. In addition, the first agitator gear 713 is fixed to an end portion of an agitating rod 78A (see FIG. 3) of the first agitator 75A.

The toner cartridge 9 that supplies toner can be attached to the developing unit 7. Thus, the developing unit 7 includes a toner receive portion 770 for receive the toner supplied by the toner cartridge 9. Furthermore, the developing unit 7 includes a lift mechanism 760 that holds and lifts up the toner cartridge 9.

As illustrated in FIG. 5, the developing unit 7 includes a first contact 720A which is electrically connected to the developing roller 71, and to which a voltage applied to the developing roller 71 is supplied. In addition, the developing unit 7 includes a second contact 720B which is electrically connected to the supplying roller 72, and to which a voltage applied to the supplying roller 72 is supplied. The above-described electric contacts are brought into contact with an electric-power supply contact (not illustrated) disposed in the apparatus body 2, so that the electric power is supplied to the developing roller 71 and the supplying roller 72.

First, a configuration for driving the developing unit 7 will be described with reference to FIG. 6. In synchronization with the movement for closing the door 21 (see FIG. 2) disposed in the apparatus body 2, a driving-force transmission member (not illustrated) for the development disposed in the apparatus body 2 moves rightward to a position at which the driving-force transmission member engages with the developing coupling 710. In contrast, in synchronization with the movement for opening the door 21 (see FIG. 2), the driving-force transmission member (not illustrated) for the development moves leftward to a position at which the driving-force transmission member disengages from the developing coupling 710.

If the apparatus body 2 operates after the door 21 (see FIG. 2) is closed, the driving force is transmitted (or sent) from the driving-force transmission member (not illustrated) for the development to the developing coupling 710, which serves as a driving-force receiving member. Then, the developing roller 71 is rotated by gears disposed around the developing coupling 710, via the developing roller gear 711, and the supplying roller 72 is rotated via the supplying roller gear 712. The driving-force transmission member (not illustrated) for the development transmits the driving force to the developing coupling 710, while allowing the positional deviation of the developing coupling 710 within a predetermined range. The developing coupling 710, the developing roller gear 711, and the supplying roller gear 712 are prevented from moving in the axis direction Da, by a side holder 719 attached to the casing 700. The side holder 719 is one example of a second side wall, and is positioned downstream of the driving-force transmission portion 716 in the first direction D1.

As illustrated in FIG. 3, the developing unit 7 agitates the toner stored in the toner storage portion 74, by using the first agitator 75A so that the toner is used up to the very end. The first agitator 75A includes the agitating rod 78A and an agitating sheet 79A. The first agitator 75A can be rotated by the driving force transmitted from the developing coupling 710 and received by the first agitator gear 713 via the idle gear 715A (see FIG. 7). The toner stored in the toner storage portion 74 and located in the vicinity of the first agitator 75A is agitated by the first agitator 75A, then supplied toward the supplying roller 72, and then supplied to the developing roller 71 by the supplying roller 72.

### Configuration of Photosensitive Member Unit and Support of Developing Unit

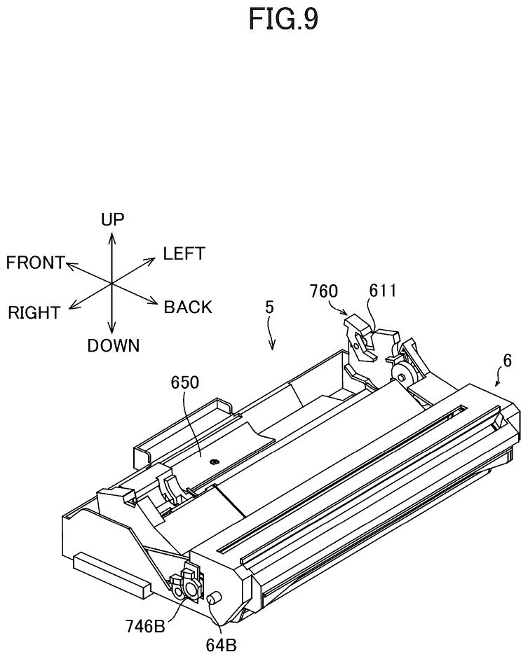

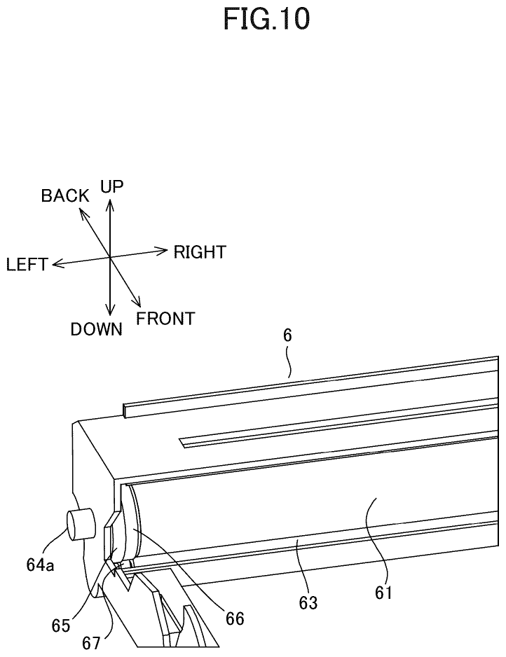

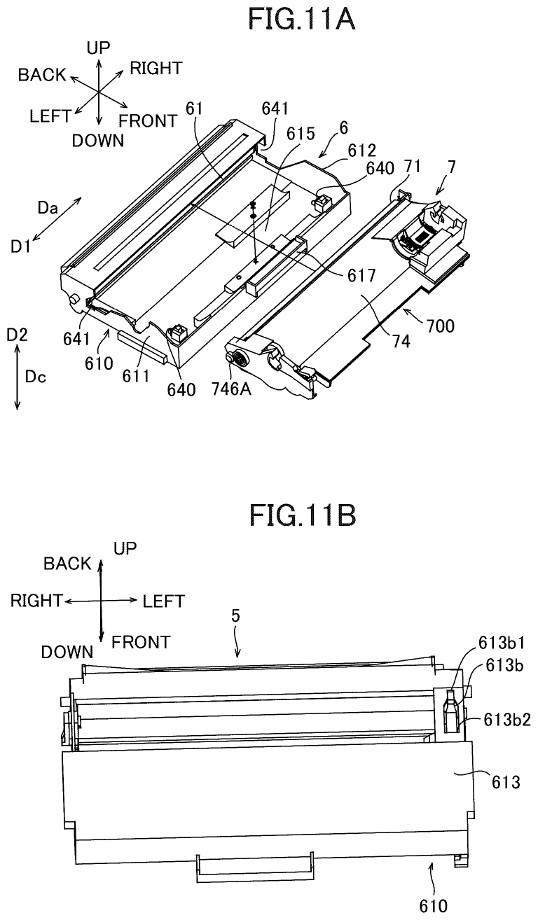

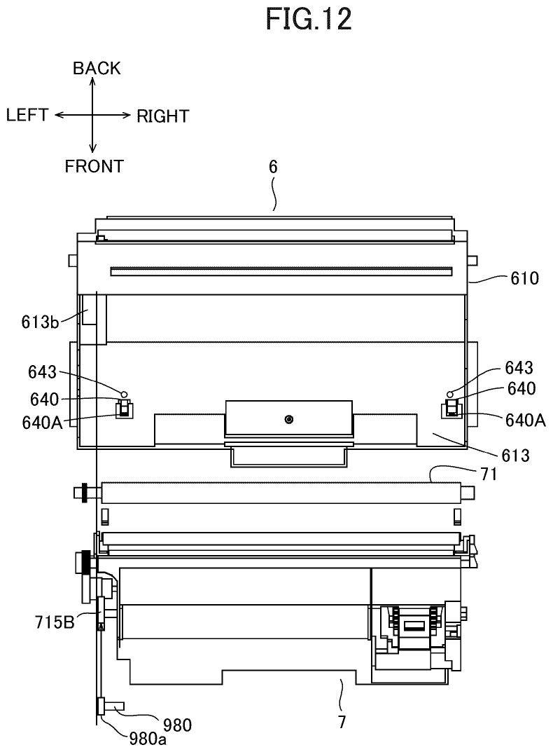

Next, a configuration of the photosensitive member unit 6 will be described in detail. FIG. 9 is a perspective view of the process cartridge 5. FIG. 10 is a partial perspective view of the photosensitive member unit 6. Each of FIGS. 11A and 11B is a perspective view of the developing unit 7 and the photosensitive member unit 6. FIG. 12 is a plan view illustrating a relationship in arrangement, in the right-and-left direction, between the photosensitive member unit 6, the developing unit 7, and the developing roller 71.

As illustrated in FIGS. 11A and 11B, the photosensitive member unit 6 includes the frame 610, the photosensitive drum 61, and the transfer roller 63. The frame 610 includes a bottom surface 613, and a pair of a left side wall 611 and a right side wall 612. The photosensitive drum 61 and the transfer roller 63 are rotatably supported by a back portion of the frame 610. The photosensitive member unit 6 is one example of a drum unit. The bottom surface 613 has a shape elongated in the axis direction Da. The left side wall 611 is one example of a first side wall. The left side wall 611 extends from the bottom surface 613 in a second direction D2 (i.e., an upward direction) that is an intersecting direction that intersects the axis direction Da, and is positioned inside with respect to the driving-force transmission portion 716 in the axis direction Da. In addition, the left side wall 611 is positioned outside in the axis direction Da, with respect to the toner cartridge 9 attached to the process cartridge 5. That is, the left side wall 611 is positioned downstream of the driving-force transmission portion 716, and downstream of the toner cartridge 9 in the first direction D1.

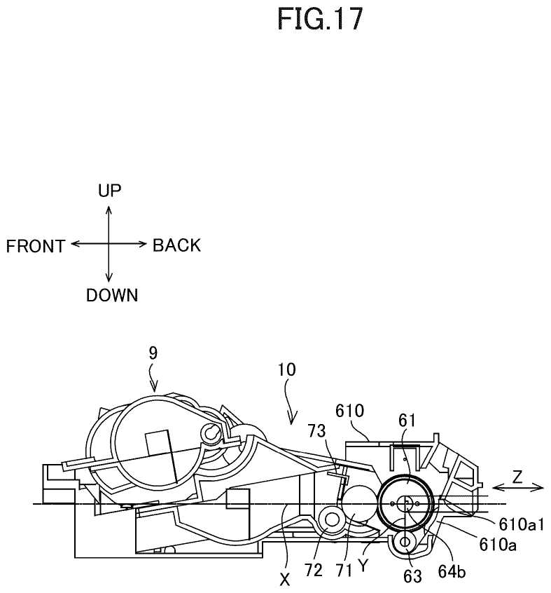

The photosensitive drum 61 is configured such that a photosensitive layer is applied to the outer surface of a drum pipe made of aluminum (the configuration is not illustrated). The surface of the photosensitive drum 61 abuts against the surface of the transfer roller 63. The frame 610 has the opening 610a (see FIG. 3) through which the sheet, to which an image has been transferred, is discharged. As illustrated in FIG. 17, an upper edge 610a1 of the opening 610a is positioned within an area onto which a drum shaft 64b is projected in a direction Z perpendicular to a line Y that connects the center of the photosensitive drum 61 and the center of the transfer roller 63. If the opening 610a is made too large, a user may touch the photosensitive drum 61. With this arrangement, however, a user can be prevented from touching the photosensitive drum 61, and in addition to this, the sheet can be prevented from being caught by the opening 610a when discharged from the opening 610a.

As illustrated in FIG. 11A, the frame 610 includes an attachment portion 615, a holding portion 617, and a pressing member 640 which are disposed in a front portion of the frame 610. The attachment portion 615 is a portion to which the developing unit 7 can be attached. The holding portion 617 is used for a user to hold the photosensitive member unit 6. The pressing member 640 presses the developing unit 7. In addition, the toner storage portion 74 of the developing unit 7 attached to the attachment portion 615 is disposed between the left side wall 611 and the right side wall 612 in the right-and-left direction (see FIG. 9).

As illustrated in FIG. 11A, in the left side wall 611 and the right side wall 612 of the frame 610, a receiving portion 641 is formed in front of the photosensitive drum 61 for receiving rotation-shaft receiving members 746A and 746B (see FIG. 9) of the developing roller 71. The receiving portion 641 is a recess portion that is substantially U-shaped, and that is opened toward the front side. The rotary shaft (not illustrated) of the developing roller 71 is inserted into the receiving portion 641. The receiving portion 641 is one example of a unit positioning portion, and supports the developing unit 7 while positioning the developing unit 7 with respect to the photosensitive member unit 6.

Next, the positioning of the developing unit 7 with respect to the photosensitive member unit 6 in the axis direction Da will be described. As illustrated in FIG. 11B, in the bottom surface 613 of the frame 610, a hole 613b is formed on the developing coupling side (i.e., the left side) in the axis direction Da. An edge line 613b1 of the hole 613b on the photosensitive drum 61 side in the front-and-back direction is shorter in the right-and-left direction, than an edge line 613b2 of the hole 613b opposite to the edge line 613b1. In addition, as illustrated in FIG. 8, a rib 730c that corresponds to the hole 613b is disposed below a left support portion 730 of the casing 700. The left support portion 730 is attached on the developing coupling side (i.e., on the left side) in the axis direction Da. A portion of the rib 730c (on the front side) separated more from the developing roller 71 is longer in the axis direction, than a portion of the rib 730c separated less from the developing roller 71.

Furthermore, as illustrated in FIG. 12, when viewed from a direction perpendicular to the axis direction Da (that is, when viewed from the front side), the hole 613b is formed on the left side (i.e., a driving side) with respect to a gear portion 980a of a conveyance screw gear 980 of the below-described toner cartridge 9. That is, since the hole 613b is formed in the vicinity of the left side wall 611, the deterioration in strength of the frame 610 caused by the hole 613b can be reduced. As illustrated in FIG. 11B, the rib 730c fits in the hole 613b, so that the developing unit 7 is positioned with respect to the photosensitive member unit 6 in the axis direction Da.

In addition, as illustrated in FIG. 12, the frame 610 includes projection portions 643 formed at both edge portions of the bottom surface 613 in the right-and-left direction and projecting upward. The projection portions 643 abut against bosses 718 (see FIG. 8) disposed on the bottom portion of the casing 700 of the developing unit 7, and thereby support the developing unit 7 such that the developing unit 7 can move. In the present embodiment, as illustrated in FIG. 9, a holding member 650 is disposed for preventing the developing unit 7 from being detached in a state where the developing unit 7 is attached to the photosensitive member unit 6.

As illustrated in FIG. 11A, the pressing member 640 is disposed at each of both end portions of a front portion of the frame 610 in the right-and-left direction, and is urged by a compression spring 640A (see FIG. 12), which serves as an urging member, toward a direction that extends from the front side toward the back side. Thus, the pressing member 640 presses a corresponding boss 718 (see FIG. 8) disposed on the casing 700 of the developing unit 7 by using the urging force of the compression spring 640A (see FIG. 12) toward a direction that extends from the front side toward the back side. Since the developing unit 7 is pressed by the pressing member 640, the developing roller 71 is urged toward the photosensitive drum 61.

In addition, as illustrated in FIG. 10, a photosensitive-member gear 65 and a transfer gear 66 are fixed to the left end portion of the photosensitive drum 61, and rotate together with the photosensitive drum 61. If the process cartridge 5 is attached to the apparatus body 2, a driving gear (not illustrated) of the apparatus body 2 and the photosensitive-member gear 65 mesh with each other. As a result, the driving force is transmitted to the photosensitive drum 61 and the transfer gear 66, so that the photosensitive drum 61 can rotate. Since the transfer gear 66 meshes with a transfer roller gear 67 fixed to the left end portion of the transfer roller 63, the transfer roller 63 can also rotate.

### Configuration of Toner Cartridge

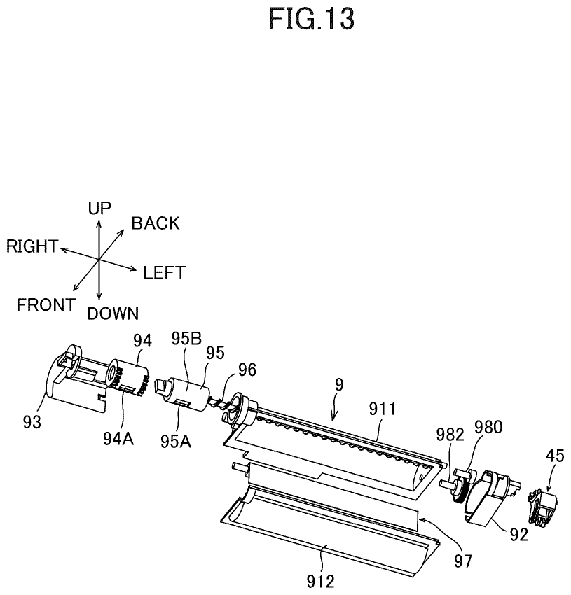

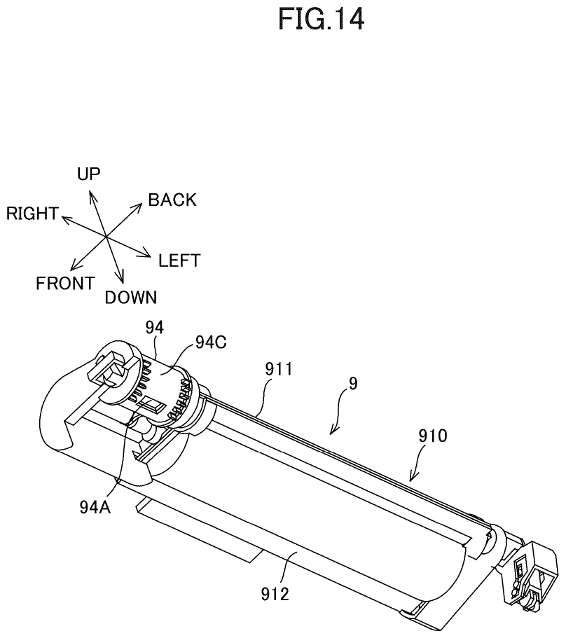

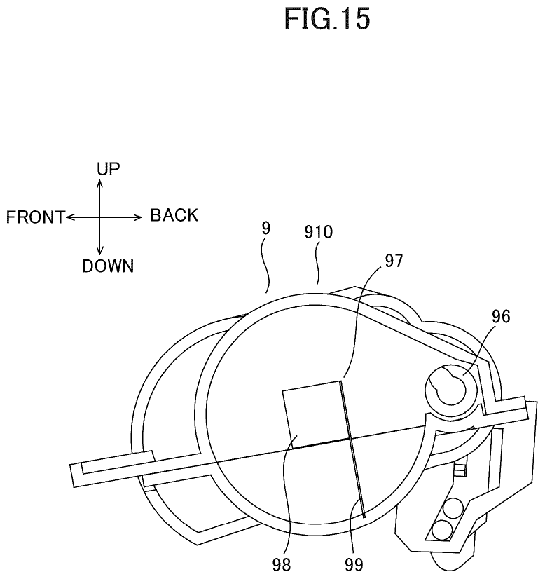

Next, a configuration of the toner cartridge 9 will be described. FIG. 13 is an exploded perspective view of the toner cartridge 9. FIG. 14 is a perspective view in which the toner cartridge 9 is viewed from below. FIG. 15 is a cross-sectional view of the toner cartridge 9.

As illustrated in FIG. 13, the toner cartridge 9 includes a container member 911, a bottom member 912, a side cover 92, a side cover 93, a discharge-port forming member 94, a discharging shutter 95, a conveyance screw 96, and a second agitator 97. In addition, the toner cartridge 9 includes a memory holder unit 45, the conveyance screw gear 980, and a second agitator gear 982. The conveyance screw gear 980 and the second agitator gear 982 are used for transmitting the driving force.

As illustrated in FIG. 14, a toner container 910 is constituted by the container member 911 and the bottom member 912, and stores the toner. The discharge-port forming member 94 is fixed to one end portion of the toner container 910 in the longitudinal direction (i.e., the axis direction Da). The discharge-port forming member 94 has a discharge-port forming surface 94C formed on the outer circumferential portion of the discharge-port forming member 94. In the discharge-port forming surface 94C, a discharge port 94A is formed for discharging the toner to the outside.

As illustrated in FIG. 15, the conveyance screw 96 and the second agitator 97 are rotatably disposed in the toner container 910. The conveyance screw 96 and the second agitator 97 are respectively rotated by the driving force transmitted by the conveyance screw gear 980 and the second agitator gear 982 disposed outside the toner container 910 (see FIG. 13). Similar to the first agitator 75A (see FIG. 3), the second agitator 97 is constituted by a second agitating rod 98 and a second agitating sheet 99. The toner stored in the toner container 910 is agitated by the second agitator 97, then conveyed toward the conveyance screw 96, then conveyed rightward to the discharge port 94A, illustrated in FIG. 13, by the conveyance screw 96, and then discharged from the discharge port 94A.

As illustrated in FIG. 13, in the discharge-port forming member 94, the discharging shutter 95 is rotatably disposed. The discharging shutter 95 includes a toner passage hole 95A and a closing portion 95B, and can discharge the toner if the toner passage hole 95A and the discharge port 94A match each other. On the other hand, if the closing portion 95B faces the discharge port 94A, the closing portion 95B prevents the toner from being discharged, and prevents the toner stored in the toner container 910, from leaking when the toner cartridge 9 is carried, for example. That is, the toner passage hole 95A is one example of a developer discharge port, and can discharge the developer to the outside of the toner cartridge 9.

### Support of Toner Cartridge

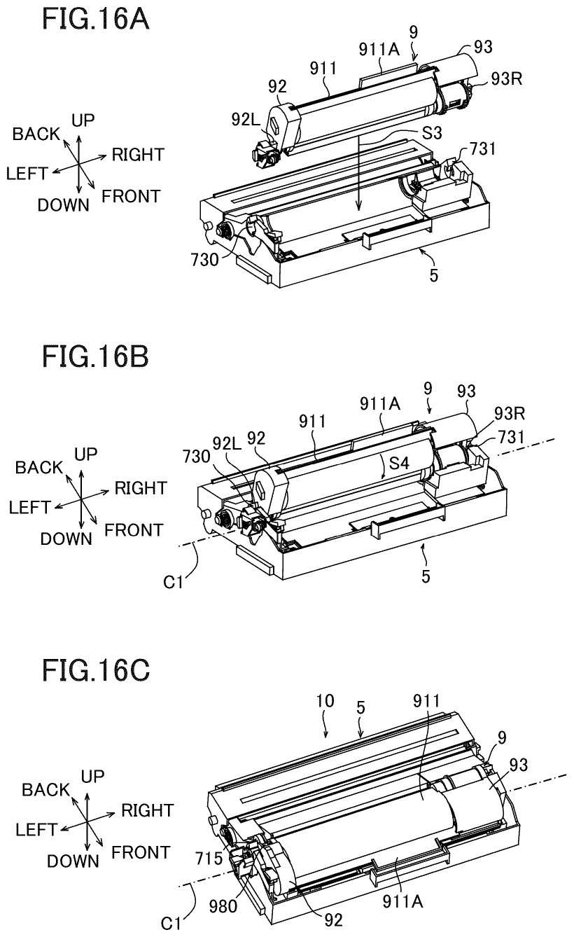

Next, a configuration for supporting the toner cartridge 9 will be described. Each of FIGS. 16A to 16C is a perspective view of the toner cartridge 9 and the process cartridge 5. FIG. 16A illustrates a state before the toner cartridge 9 is attached to the process cartridge 5. FIG. 16B illustrates a state where the toner cartridge 9 is being attached to the process cartridge 5. FIG. 16C illustrates a state where the attachment of the toner cartridge 9 is completed.

As illustrated in FIGS. 16A to 16C, the toner cartridge 9 can be detachably attached to the developing unit 7. The container member 911 of the toner cartridge 9 includes a handle portion 911A. In addition, the side cover 92 and the side cover 93 are fixed to both end portions of the toner cartridge 9 in the longitudinal direction (i.e., the axis direction Da). The side cover 92 includes a supported projection 92L that is a positioned portion via which the toner cartridge 9 is supported by the developing unit 7, and side cover 93 includes a supported projection 93R that is a positioned portion via which the toner cartridge 9 is supported by the developing unit 7. The developing unit 7 includes the left support portion 730 that supports the supported projection 92L, and a right support portion 731 that supports the supported projection 93R. The supported projection 92L and the supported projection 93R are pivotally supported by the left support portion 730 and the right support portion 731.

In a case where the toner cartridge 9 is attached to the developing unit 7, a user moves the toner cartridge 9 in an S3 direction (i.e., a downward direction), from above, toward the developing unit 7 while holding the handle portion 911A, as illustrated in FIG. 16A. As illustrated in FIG. 16B, if the toner cartridge 9 is moved in the S3 direction, the supported projection 92L and the supported projection 93R are pivotally supported by the left support portion 730 and the right support portion 731. In this state, the toner cartridge 9 is pivoted around the supported projection 92L and the supported projection 93R in an S4 direction. As a result, the attachment of the toner cartridge 9 is completed and the cartridge unit 10 is formed, as illustrated in FIG. 16C.

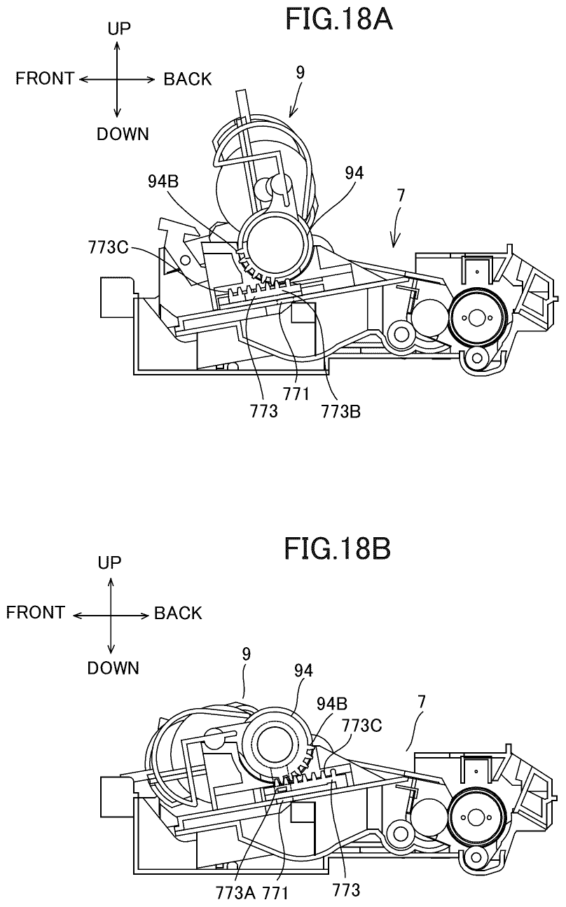

That is, the left support portion 730 is one example of a rotation support portion, and rotatably supports the toner cartridge 9 when the toner cartridge 9 is moved between a first position (see FIG. 18A) and a second position (see FIG. 18B), which are described below. In addition, the supported projection 92L is one example of a rotation supported portion, and is rotatably supported by the left support portion 730.

In the attachment completion state illustrated in FIG. 16C, the conveyance screw gear 980 of the toner cartridge 9 and the idle gear 715B of the developing unit 7 mesh with each other. As a result, the driving force from the developing unit 7 can be transmitted to the toner cartridge 9. In addition, as illustrated in FIG. 17, if the toner cartridge 9 is attached to the process cartridge 5, the toner cartridge 9 is disposed above a line X that is perpendicular to a line Y connecting the center of the transfer roller 63 and the center of the photosensitive drum 61, and that passes through the center of the photosensitive drum 61.

### Opening/Closing Operation of Receive Shutter

Next, an opening/closing operation of a receive shutter 773 will be described. Each of FIGS. 18A and 18B is a diagram illustrating an opening/closing operation of the receive shutter 773 of the developing unit 7. FIG. 18A illustrates a state where the receive shutter 773 is closed. FIG. 18B illustrates a state where the receive shutter 773 is opened.

As illustrated in FIG. 6, the toner receive portion 770 of the developing unit 7 includes a toner receive port 771 formed in a top surface of the casing 700, a receive shutter seal 772, the receive shutter 773, a receive port cover 774, and a connecting seal 775. In the receive shutter seal 772, the receive shutter 773, the receive port cover 774, and the connecting seal 775, hole portions 772A, 773A, 774A, and 775A are formed, respectively. The hole portion 772A of the receive shutter seal 772, the hole portion 774A of the receive port cover 774, and the hole portion 775A of the connecting seal 775 are formed so as to match the toner receive port 771. The receive shutter 773 includes a shielding portion 773B in addition to the hole portion 773A, and is disposed so as to be able to slide. The slide movement of the receive shutter 773 allows the toner receive port 771 to be opened and closed. That is, the toner receive port 771 is one example of a developer receive port, and can receive the developer discharged from the toner passage hole 95A of the toner cartridge 9.

As illustrated in FIGS. 18A and 18B, the opening/closing operation of the receive shutter 773 is performed in synchronization with the attachment and detachment operation of the toner cartridge 9. On the outer circumferential surface of the discharge-port forming member 94 of the toner cartridge 9, a driving projection group 94B is disposed. In addition, on the receive shutter 773, a driven projection group 773C is disposed.

As described above, the state of the toner cartridge 9 is changed to the attachment completion state by the toner cartridge 9 performing the pivot movement in the attachment process of the toner cartridge 9 to the developing unit 7. FIG. 18A illustrates a state before the pivot movement is performed in the attachment process. In this state, since the shielding portion 773B of the receive shutter 773 faces the toner receive port 771, the toner receive port 771 is closed. In this state, the driving projection group 94B and the driven projection group 773C are engaged with each other.

FIG. 18B illustrates a state where the attachment of the toner cartridge 9 is completed by pivoting the toner cartridge 9. Since the toner cartridge 9 is pivoted downward in a state where the engagement between the driving projection group 94B and the driven projection group 773C is kept, the receive shutter 773 slides backward in synchronization with the pivot movement of the toner cartridge 9. As a result, the position of the hole portion 773A of the receive shutter 773 and the position of the toner receive port 771 match each other, and the toner receive port 771 is opened.

Similarly, in a case where the toner cartridge 9 is separated from the developing unit 7, the receive shutter 773 slides frontward in synchronization with the upward pivot movement of the toner cartridge 9, so that the toner receive port 771 is closed.

As described above, in a state where the toner cartridge 9 is attached to the developing unit 7, the toner receive port 771 is opened, and the developing unit 7 can receive the toner. In contrast, in a state where the toner cartridge 9 is not attached to the developing unit 7, the toner receive port 771 is closed. In this state, foreign substances are prevented from entering the developing unit 7, and the toner is prevented from leaking to the outside. That is, the toner cartridge 9 can move with respect to the process cartridge 5, between the first position illustrated in FIG. 18A and the second position illustrated in FIG. 18B. The first position is a position at which the toner passage hole 95A and the toner receive port 771 do not communicate with each other. The second position is a position to which the toner cartridge 9 is rotated from the first position around a rotation axis C1 (see FIG. 16C), and at which the toner passage hole 95A and the toner receive port 771 communicate with each other.

### Opening/Closing Operation of Discharging Shutter

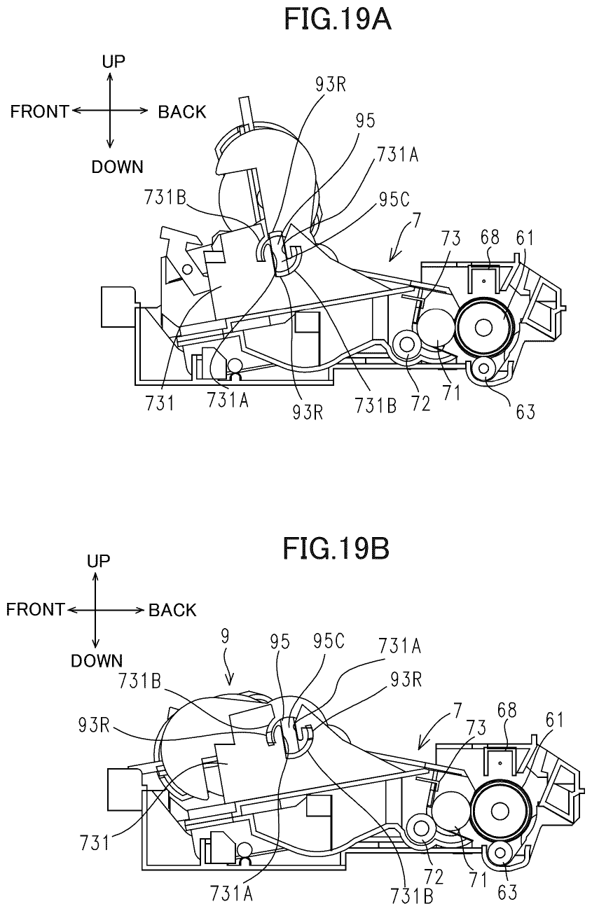

Next, an opening/closing operation of the discharging shutter 95 will be described. Each of FIGS. 19A and 19B is a diagram illustrating an opening/closing operation of the discharging shutter 95 of the toner cartridge 9. FIG. 19A illustrates a state where the discharging shutter 95 is closed. FIG. 19B illustrates a state where the discharging shutter 95 is opened.

As described above, if the position of the discharge port 94A of the discharge-port forming member 94 illustrated in FIG. 13 and the position of the toner passage hole 95A of the discharging shutter 95 match each other, the discharge port 94A is opened. In addition, if the closing portion 95B of the discharging shutter 95 faces the discharge port 94A, the discharge port 94A is closed. Similar to the opening/closing operation of the receive shutter 773, the opening/closing operation of the discharging shutter 95 is performed also in synchronization with the pivot movement of the toner cartridge 9 performed when the toner cartridge 9 is attached to or detached from the developing unit 7.

As illustrated in FIGS. 19A and 19B, a locked projection 95C is formed on the discharging shutter 95, and is disposed inside the supported projection 93R in the radial direction. In addition, in the right support portion 731 of the developing unit 7, a locking portion 731A and a recess portion 731B are formed.

FIG. 19A illustrates a state before the pivot movement of the toner cartridge 9 is performed in the attachment process of the toner cartridge 9. In this state, since the closing portion 95B (see FIG. 13) of the discharging shutter 95 and the discharge port 94A (see FIG. 13) face each other, the discharge port 94A (see FIG. 13) is closed. In this state, the locked projection 95C is caught by the locking portion 731A, so that the discharging shutter 95 is prevented from pivoting with respect to the developing unit 7.

FIG. 19B illustrates a state where the attachment of the toner cartridge 9 is completed by pivoting the toner cartridge 9. The toner cartridge 9 is pivoted with respect to the developing unit 7 in a state where the discharging shutter 95 is prevented from pivoting. Since the supported projection 93R can enter the recess portion 731B, components of the toner cartridge 9 other than the discharging shutter 95 are not prevented from pivoting.

In this manner, the toner cartridge 9 is pivoted downward in the attachment process of the toner cartridge 9, so that the discharging shutter 95 pivots relative to the toner cartridge 9 in the interior of the toner cartridge 9. As a result, the position of the toner passage hole 95A (see FIG. 13) of the discharging shutter 95 and the position of the discharge port 94A (see FIG. 13) match each other, so that the discharge port 94A (see FIG. 13) is opened.

Similarly, in a case where the toner cartridge 9 is separated from the developing unit 7, the discharging shutter 95 pivots relative to the toner cartridge 9 in synchronization with the upward pivot movement of the toner cartridge 9, so that the discharge port 94A (see FIG. 13) is closed.

### Lift Mechanism for Toner Cartridge

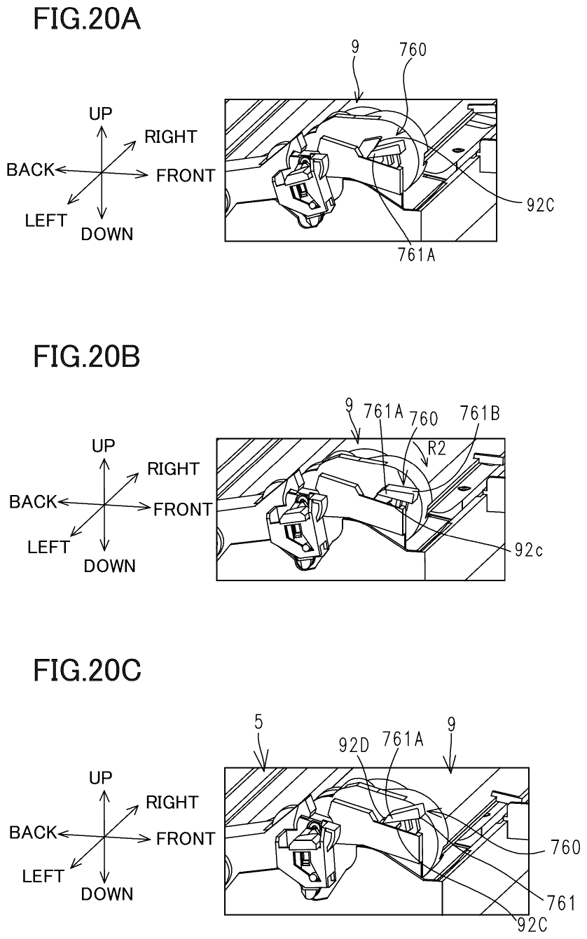

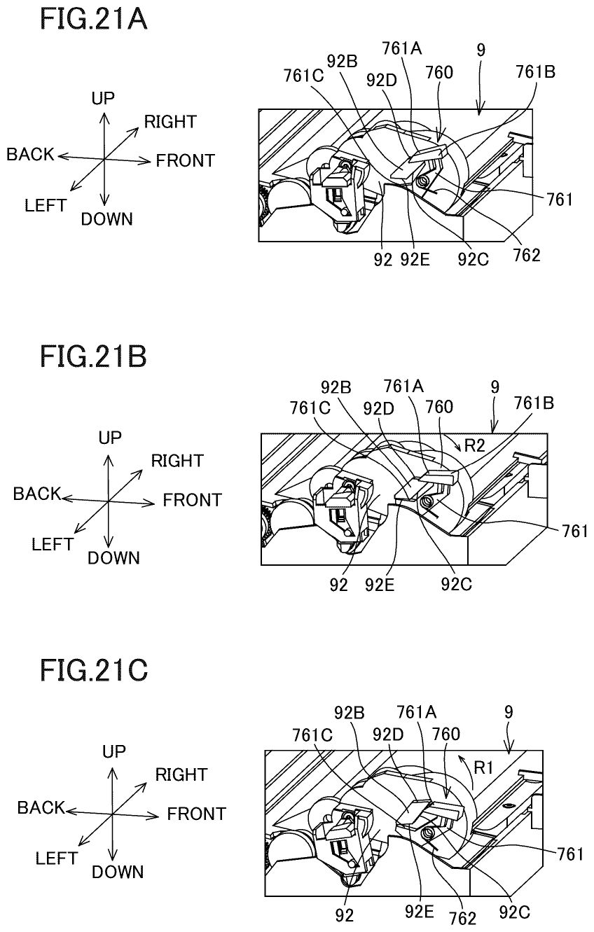

Next, a configuration of the lift mechanism 760 for the toner cartridge 9 will be described. Each of FIGS. 20A to 20C illustrates a movement of the lift mechanism 760 in the attachment process of the toner cartridge 9. FIG. 20A illustrates a state where the toner cartridge 9 is put on the lift mechanism 760 in the attachment process. FIG. 20B illustrates a state where the lift mechanism 760 is opened in the attachment process of the toner cartridge 9. FIG. 20C illustrates a state a where the attachment of the toner cartridge 9 is completed. FIGS. 21A to 21C illustrate a movement in which the attachment state of the toner cartridge 9 is changed to a lift-up state by the lift mechanism 760. Note that in FIGS. 21A to 21C, the side holder 719 of the developing unit 7 is not illustrated for convenience of description. FIG. 21A illustrates a state a where the attachment of the toner cartridge 9 is completed. FIG. 21B illustrates a state where the toner cartridge 9 is being lifted up by the lift mechanism 760. FIG. 21C illustrates a state where the state of the toner cartridge 9 has become the lift-up state.

As illustrated in FIGS. 21A to 21C, the side cover 92 of the toner cartridge 9 includes a projection portion 92B. The projection portion 92B includes an abutment surface 92C, a holding surface 92D, and a receiving surface 92E. In addition, as illustrated in FIG. 6, the lift mechanism 760 includes a boss 719A disposed on the side holder 719 of the developing unit 7, a lift member 761, and a torsion coil spring 762. The lift member 761 and the torsion coil spring 762 are attached to the boss 719A, and can pivot around the boss 719A. The lift member 761 includes an abutment portion 761A, an operation portion 761B, and a lifting portion 761C. As illustrated in FIG. 21C, the lift member 761 is urged toward a direction indicated by an arrow R1, by the torsion coil spring 762.

Next, the movement of the lift mechanism 760 in the attachment process of the toner cartridge 9 will be described with reference to FIGS. 20A to 20C. If the toner cartridge 9 is pivoted downward in the attachment process of the toner cartridge 9, the abutment surface 92C and the abutment portion 761A abut against each other and the toner cartridge 9 is put on the lift mechanism 760, as illustrated in FIG. 20A. If the pivot movement of the toner cartridge 9 is continued, the lift member 761 is pushed by the abutment surface 92C, as illustrated in FIG. 20B. As a result, the lift member 761 pivots toward a direction indicated by an arrow R2, and allows the pivot movement of the toner cartridge 9.

If the pivot movement is continued and the attachment of the toner cartridge 9 is completed, the abutment portion 761A separates from the abutment surface 92C and contacts the holding surface 92D, as illustrated in FIG. 20C. With this operation, the attachment completion state of the toner cartridge 9 can be kept by the lift member 761. That is, the lift member 761 is one example of a lock lever that locks the toner cartridge 9 on the process cartridge 5. On the other hand, the projection portion 92B is one example of a locked portion, and is locked on the lift member 761 in a case where the toner cartridge 9 is attached to the process cartridge 5.

In the present embodiment, the projection portion 92B and the lift member 761 are disposed downstream of the toner cartridge 9 in the first direction D1 (i.e., the left direction). In addition, a memory tag 40 is disposed downstream of the projection portion 92B and the lift member 761 in the first direction D1.

Next, the movement for changing the state of the toner cartridge 9 from the attachment completion state to the lift-up state will be described with reference to FIGS. 21A to 21C. As illustrated in FIG. 21A, in the attachment completion state of the toner cartridge 9, since the abutment portion 761A of the lift member 761 abuts against the holding surface 92D, the toner cartridge 9 cannot be detached from the developing unit 7. For detaching the toner cartridge 9 from the developing unit 7, the lift member 761 is pivoted, as illustrated in FIG. 21B, toward a direction indicated by an arrow R2, by operating the operation portion 761B of the lift member 761 so that the operation portion 761B is pushed down. With this operation, the lifting portion 761C of the lift member 761 abuts against the receiving surface 92E, so that the toner cartridge 9 can pivot. After that, if the operation portion 761B is released, the lift member 761 pivots toward a direction indicated by an arrow R1, as illustrated in FIG. 21C, due to the urging force of the torsion coil spring 762. As a result, the abutment surface 92C and the abutment portion 761A abut against each other, so that the state of the toner cartridge 9 becomes the lift-up state where the toner cartridge 9 is put on the lift mechanism 760. In this state, the toner cartridge 9 can be detached from the developing unit 7.

### Arrangement of Memory Tag

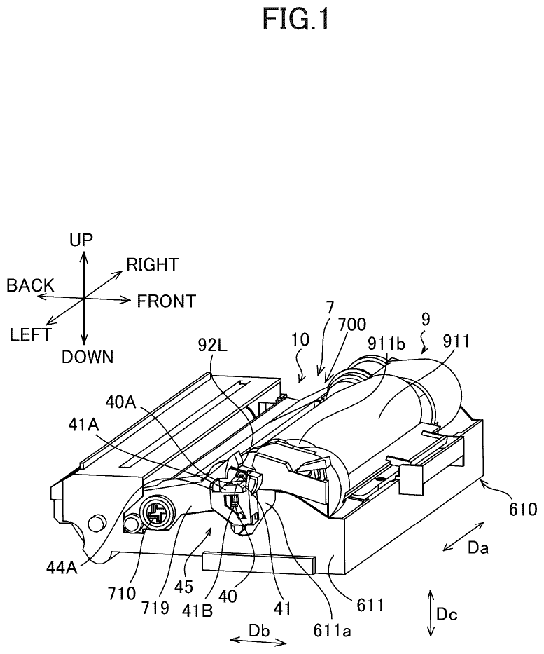

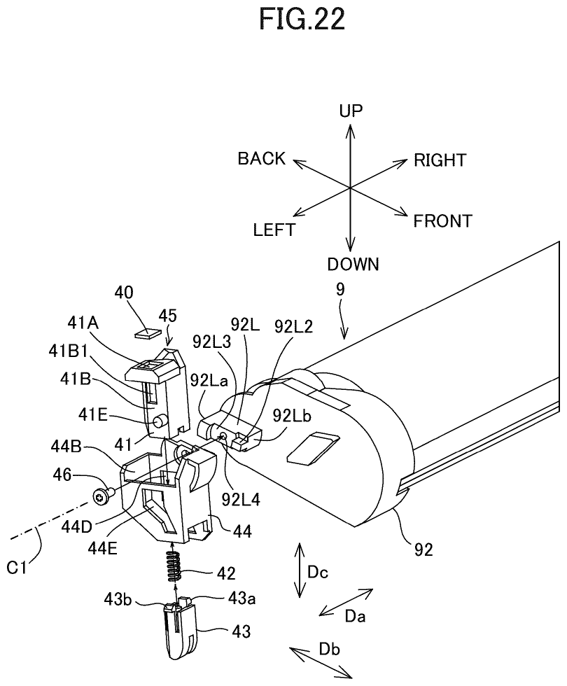

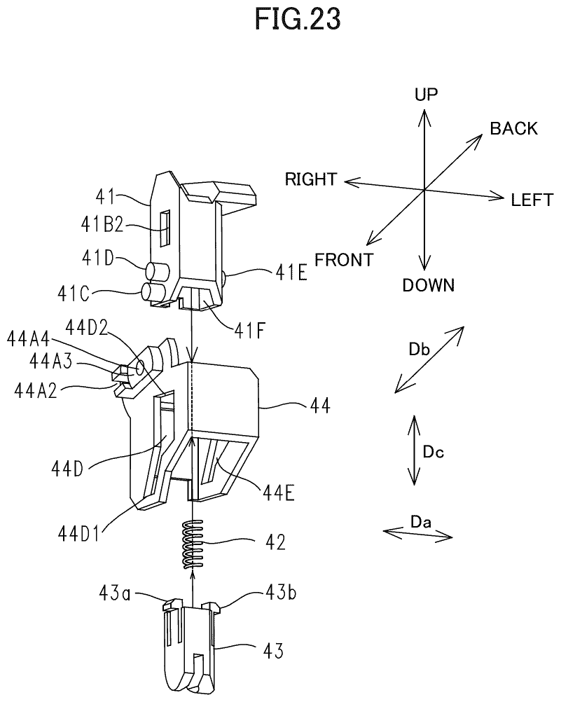

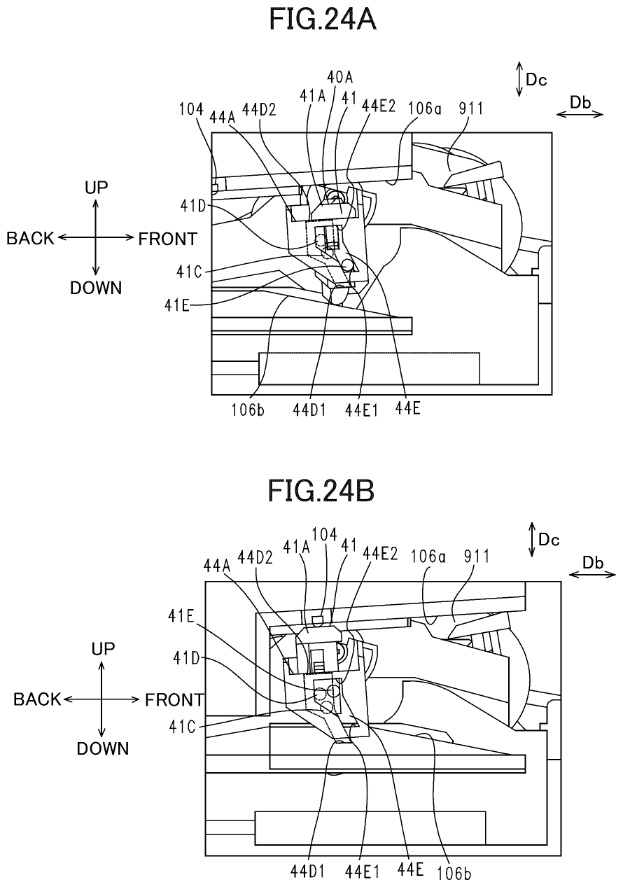

Next, a memory tag of the first embodiment will be described. FIG. 1 is a perspective view in which the cartridge unit 10 is viewed from diagonally above. FIG. 22 is a perspective view in which the assembling of the memory holder unit 45 is viewed from diagonally above. FIG. 23 is a perspective view in which the assembling of the memory tag is viewed from diagonally below and from the inside in the axis direction Da. FIGS. 24A and 24B are diagrams which illustrate two positions of the memory holder, and in which the image forming apparatus 1 is viewed from the left side. Note that in FIGS. 24A and 24B, the exterior of the image forming apparatus 1 is not illustrated. FIG. 24A illustrates a state where the attachment of the cartridge unit 10 is started. FIG. 24B illustrates a state where the attachment of the cartridge unit 10 is completed.

The memory tag 40 that is one example of a memory can store and transmit various types of information. In a state where the memory tag 40 is electrically in contact with a main-body memory contact 104 (see FIG. 24B) of the apparatus body 2, the memory tag 40 sends/receives information to/from a control portion disposed, for example, in the apparatus body 2. The information on the toner cartridge 9 is at least one of the identification information that can identify the toner cartridge 9, and the service-life information of the toner cartridge 9.

The toner cartridge 9 includes a memory holder unit 45 that guides the memory tag 40 such that the memory tag 40 can move with respect to the container member 911. As illustrated in FIG. 22, the memory holder unit 45 includes the memory tag 40, a memory holder 41 that is one example of a holder that holds the memory tag 40, a spring 42, a back-and-forth movement member 43, and a memory cover 44. As illustrated in FIG. 1, in a state where the toner cartridge 9 is attached to the casing 700, the memory tag 40 is positioned on the developing coupling 710 side (i.e., the left side) (the developing coupling 710 is a driving member) in the right-and-left direction that is the axis direction Da. In addition, in the insertion-and-drawing direction Db (i.e., the front-and-back direction) that intersects the axis direction Da, the memory tag 40 is positioned in the vicinity of the supported projection 92L of the toner cartridge 9. The side holder 719 of the developing unit 7 is positioned between the side cover 92 and a storage portion 41B of the memory holder 41 in the axis direction Da.

As illustrated in FIG. 1, the memory tag 40 has an electrical contact surface 40A. The electrical contact surface 40A is positioned at a position different from the position of the container member 911 in the axis direction Da. That is, the electrical contact surface 40A is positioned outside with respect to the container member 911. In addition, the electrical contact surface 40A has a shape elongated in the insertion-and-drawing direction Db. The electrical contact surface 40A faces upward, and intersects a line that extends in the up-and-down direction Dc.

As illustrated in FIG. 22, the memory holder 41 is a holder that holds the memory tag 40. The memory holder 41 holds the memory tag 40 such that the electrical contact surface 40A of the memory tag 40 can move with respect to the container member 911. The memory tag 40 is held by the outer surface of the memory holder 41. In addition, as illustrated in FIG. 1, the memory holder 41 is disposed side by side with the container member 911 in the axis direction Da.

The container member 911 includes a first side-surface 911b. The first side-surface 911b is positioned at one end portion of the container member 911 in the axis direction Da. The first side-surface 911b is a side surface that faces the outside of the container member 911 in the axis direction Da. The frame 610 of the cartridge unit 10 includes the left side wall 611 that faces the first side-surface 911b. The left side wall 611 is positioned between at least a portion of the memory holder 41 and the container member 911 in the axis direction Da. In addition, the left side wall 611 includes a recess portion 611a opening upward corresponding to the memory cover 44. That is, the recess portion 611a is opened toward a direction in which the toner cartridge 9 attached to the process cartridge 5 is separated from the process cartridge 5. The memory holder 41 can move with respect to the container member 911. In the present embodiment, the memory holder 41 can move in the insertion-and-drawing direction Db and the up-and-down direction Dc.

As illustrated in FIG. 22, the memory holder 41 is a member that holds the memory tag 40. The memory holder 41 includes a memory base portion 41A, the storage portion 41B, a first boss 41C (see FIG. 23), a second boss 41D (see FIG. 23), and a third boss 41E. The memory base portion 41A is a portion that holds the memory tag 40, and projects from the storage portion 41B toward the memory cover 44 in the axis direction Da. The storage portion 41B includes a hollow rectangular portion 41F (see FIG. 23), and extends from the memory base portion 41A toward a direction opposite to the memory tag 40.

In two walls of the storage portion 41B that face each other in the axis direction Da, long holes 41B1 and 41B2 (see FIGS. 22 and 23) are formed. The long holes 41B1 and 41B2 extend in the up-and-down direction Dc, and pass through the walls in the axis direction Da. Each of the first boss 41C and the second boss 41D has a substantially cylindrical shape, and projects from the storage portion 41B toward the side cover 92 in the axis direction Da (i.e., the right direction). The second boss 41D is positioned, separated from the first boss 41C by a predetermined distance in the up-and-down direction Dc. In the present embodiment, the second boss 41D is positioned above the first boss 41C. The third boss 41E projects from the storage portion 41B toward the memory cover 44 in the axis direction Da (i.e., the left direction).

The back-and-forth movement member 43 has a shape elongated in the up-and-down direction Dc, and includes a space portion formed in the back-and-forth movement member 43 and surrounded by four walls disposed in the front-and-back direction and the right-and-left direction. In addition, a spring 42 that is a compression coil spring whose longitudinal direction is equal to the up-and-down direction Dc is accommodated in and attached to the space portion. Two walls that are of the four walls that form the space portion, and that face each other in the axis direction Da have snap-fits 43a and 43b formed on upper portions of the two walls. The back-and-forth movement member 43 is inserted into the memory holder 41 from the rectangular portion 41F (see FIG. 23) of the memory holder 41 such that the back-and-forth movement member 43 is forced to face upward and pressed. As a result, the snap-fits 43a and 43b are engaged with and held by the long holes 41B1 and 41B2 that pass through the side surfaces of the memory holder 41. With this operation, the memory holder 41 holds the back-and-forth movement member 43 such that the back-and-forth movement member 43 can move in the up-and-down direction Dc.

The memory cover 44 includes a first long hole 44D on the right side, and a second long hole 44E on the left side. The memory holder 41 is inserted, while pressed, into the memory cover 44 from an opening portion 44B of the memory cover 44, so that the first boss 41C and the second boss 41D engage with the first long hole 44D, and the third boss 41E engages with the second long hole 44E. With this operation, the memory tag 40 is held so as to be able to move in the toner cartridge 9. That is, the memory cover 44 is one example of a support member, and supports the memory holder 41 such that the memory cover 44 can move with respect to the toner cartridge 9 in directions that intersect the axis direction Da.

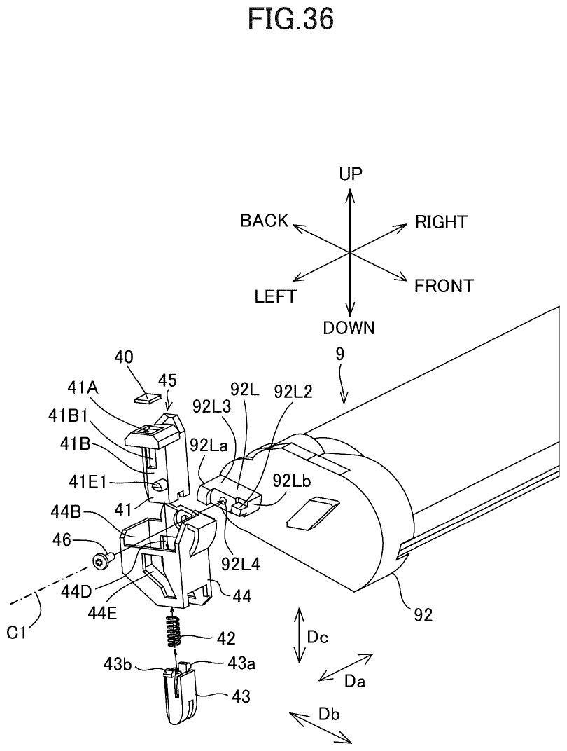

Note that the configuration of the memory cover 44 is not limited to the configuration illustrated in FIG. 22. For example, as illustrated in FIG. 36, a third boss 41E1 that has a substantially cylindrical shape may be chamfered for easily press-fitting the memory holder 41 to the memory cover 44. Although not illustrated, the first boss 41C and the second boss 41D may also be chamfered, like the third boss 41E1. If the bosses are chamfered, the ease of assembly can be improved. That is, if each boss has a shape in which an edge portion of a projecting end of the boss is cut, the edge portions of the projecting ends of the bosses 41C and 41D are easily guided on an inner surface of the memory cover 44 when the memory holder 41 is press-fitted to the memory cover 44, improving the ease of assembly.

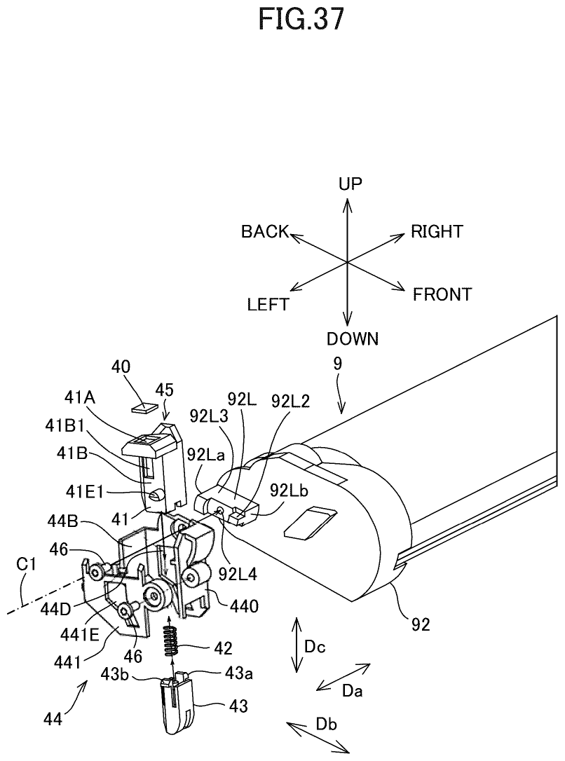

In addition, for increasing the ease of assembly, the memory cover 44 may be constituted, as illustrated in FIG. 37, by two members: a cover body 440 and a cover 441. In this case, the memory holder 41 is inserted into the cover body 440, and after that, the cover body 440 can be covered by the cover 441. In this configuration, the third boss 41E engages with a long hole 441E of the cover 441.

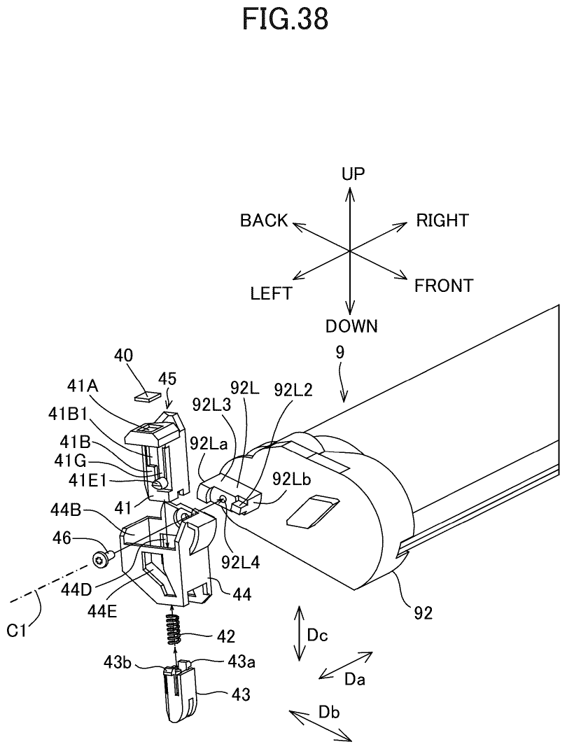

In another case, as illustrated in FIG. 38, the memory holder 41 may include a plate spring portion 41G that elastically supports the third boss 41E1 in the axis direction Da. Although not illustrated, each of the first boss 41C and the second boss 41D may also be supported by a plate spring portion, like the third boss 41E1. In this case, since the boss can appear elastically in the axis direction Da, the snap-fit configuration can be achieved for a long hole 44E. As a result, the ease of assembly can be improved.

As illustrated in FIGS. 24A and 24B, the first long hole 44D and the second long hole 44E are long holes elongated in the up-and-down direction Dc. The first long hole 44D includes a lower edge portion 44D1, and an upper edge portion 44D2 separated from the lower edge portion 44D1 in the up-and-down direction Dc. The length of the upper edge portion 44D2 in the insertion-and-drawing direction Db is longer than the length of the lower edge portion 44D1 in the insertion-and-drawing direction Db. In a state where the cartridge unit 10 is attached to the apparatus body 2, the lower edge portion 44D1 is positioned below the upper edge portion 44D2. The lower edge portion 44D1 prevents the first boss 41C from moving in the insertion-and-drawing direction Db. The upper edge portion 44D2 allows the first boss 41C to move in the insertion-and-drawing direction Db.

The second long hole 44E includes a lower edge portion 44E1, and an upper edge portion 44E2 separated from the lower edge portion 44E1 in the up-and-down direction Dc. The length of the upper edge portion 44E2 in the insertion-and-drawing direction Db is longer than the length of the lower edge portion 44E1 in the insertion-and-drawing direction Db. In a state where the cartridge unit 10 is attached to the apparatus body 2, the lower edge portion 44E1 is positioned below the upper edge portion 44E2. The lower edge portion 44E1 prevents the third boss 41E from moving in the insertion-and-drawing direction Db. The upper edge portion 44E2 allows the third boss 41E to move in the insertion-and-drawing direction Db.

As illustrated in FIG. 24A, in a case where the toner cartridge 9 is not attached to the image forming apparatus 1, the electrical contact surface 40A is positioned at a first position in the toner cartridge 9. In a state where the electrical contact surface 40A is positioned at the first position, the memory holder 41 is held by the memory cover 44. Specifically, in a state where the electrical contact surface 40A is positioned at the first position, the memory base portion 41A of the memory holder 41 is in contact with a holding surface 44A of the memory cover 44. In addition, in a state where the electrical contact surface 40A is positioned at the first position, the third boss 41E is located closer to or is in contact with the lower edge portion 44E1 of the second long hole 44E. In addition, in a state where the electrical contact surface 40A is positioned at the first position, the first boss 41C is located closer to or is in contact with the lower edge portion 44D1 of the first long hole 44D. That is, in a state where the electrical contact surface 40A is positioned at the first position, the memory holder 41 is prevented from moving with respect to the side cover 92 in the insertion-and-drawing direction Db.

### Attachment of Cartridge Unit to Apparatus Body

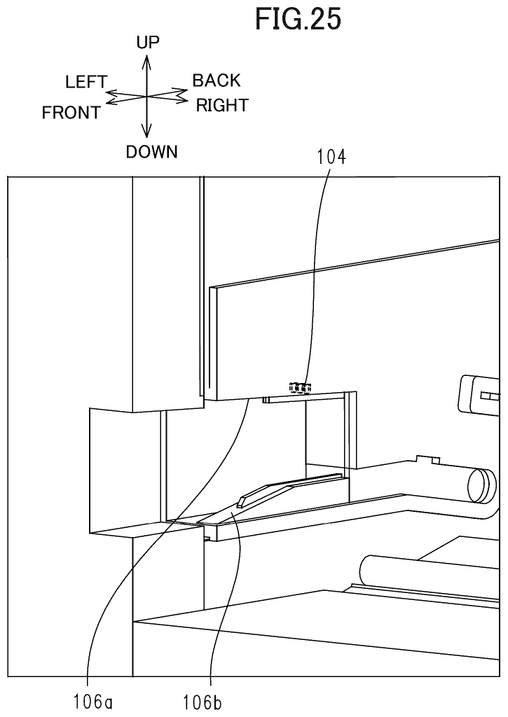

Next, the attachment of the cartridge unit 10 to the apparatus body 2 will be described with reference to FIG. 25. FIG. 25 is a perspective view illustrating the interior of the apparatus body 2. As illustrated in FIG. 25, the apparatus body 2 includes a lower guide 106b, an upper guide 106a, and a main-body memory contact 104. The lower guide 106b is a guide that contacts the lower end of the back-and-forth movement member 43 and guides the back-and-forth movement member 43. The upper guide 106a is a guide that contacts the upper end of the memory holder 41 and guides the memory holder 41. The main-body memory contact 104 is a contact point that can contact the electrical contact surface 40A of the memory tag 40.

As illustrated in FIG. 24B, if the cartridge unit 10 is attached to the apparatus body 2, the memory holder 41 is lifted by the lower guide 106b of the apparatus body 2, via the back-and-forth movement member 43 and the spring 42. That is, the memory base portion 41A of the memory holder 41 is separated upward from the holding surface 44A of the memory cover 44. With this operation, the memory tag 40 is positioned at a second position, and is urged against the main-body memory contact 104 by the urging force of the spring 42. As a result, the electrical contact surface 40A contacts the main-body memory contact 104. In this case, the third boss 41E is separated from the inner surface of the lower edge portion 44E1 of the second long hole 44E. In addition, the first boss 41C is separated from the lower edge portion 44D1 of the first long hole 44D. With this operation, in a state where the electrical contact surface 40A is positioned at the second position, the memory holder 41 is allowed to move with respect to the side cover 92 in the insertion-and-drawing direction Db. Thus, the sliding friction produced in the insertion-and-drawing direction Db when the electrical contact surface 40A contacts the main-body memory contact 104 can be reduced, so that the wear and damage of the electrical contact surface 40A can be reduced.

Since the memory holder 41 is configured as described above, the memory tag 40 can move between the first position illustrated in FIG. 24A and the second position illustrated in FIG. 24B, with respect to the container member 911 in the insertion-and-drawing direction Db and the up-and-down direction Dc.

### Attachment of Memory Holder Unit to Side Cover

Next, the attachment of the memory holder unit 45 to the side cover 92 will be described with reference to FIGS. 22 and 23. As illustrated in FIG. 22, in an end surface of the supported projection 92L that extends from the side surface of the side cover 92 in the axis direction Da, a recess portion 92L3, a rib 92L2, and a screw hole 92L4 are disposed. The recess portion 92L3 has wall portions in the insertion-and-drawing direction Db. The rib 92L2 is formed in front of the recess portion 92L3, and extends in the insertion-and-drawing direction Db. In the supported projection 92L, the radius from the center of rotation (i.e., the rotation axis C1) performed in the attachment operation, to the back end of the supported projection 92L is equal to the radius from the center of rotation to the front end of the supported projection 92L.

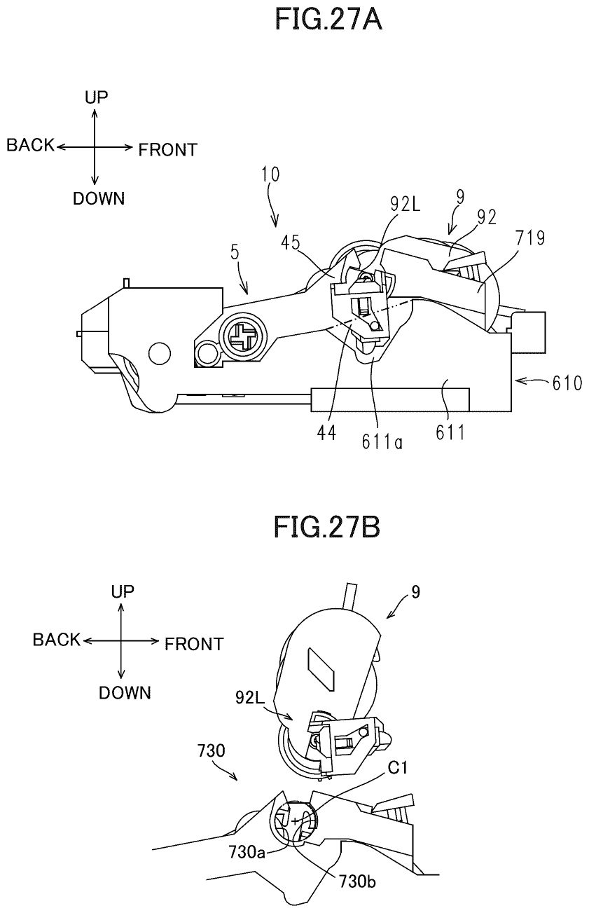

In the present embodiment, as illustrated in FIG. 22, the supported projection 92L includes a first supported portion 92La and a second supported portion 92Lb. The first supported portion 92La is disposed at a first distance L1 from the rotation axis C1 in a first intersecting direction (e.g., the back direction) that intersects the axis direction Da. The second supported portion 92Lb is disposed at the first distance L1 from the rotation axis C1 in a second intersecting direction (e.g., the front direction) that intersects the axis direction Da, and that is different from the first intersecting direction. In addition, as illustrated in FIG. 27B, the left support portion 730 includes a first support portion 730a and a second support portion 730b. The first support portion 730a guides the first supported portion 92La when the toner cartridge 9 moves between the first position and the second position, and positions the first supported portion 92La when the toner cartridge 9 is positioned at the second position. The second support portion 730b guides the second supported portion 92Lb when the toner cartridge 9 moves between the first position and the second position, and positions the second supported portion 92Lb when the toner cartridge 9 is positioned at the second position.

On the other hand, as illustrated in FIG. 23, in a side surface of the memory cover 44 on the right side in the axis direction Da, an elliptical projection portion 44A3, a groove portion 44A2, and a screw hole 44A4 are disposed. The longitudinal direction of the projection portion 44A3 and the groove portion 44A2 is equal to the insertion-and-drawing direction Db. The projection portion 44A3 and the groove portion 44A2 respectively fit to the recess portion 92L3 and the rib 92L2 of the side cover 92, so that the memory cover 44 is positioned. The rib 92L2 is one example of an engaging portion. The groove portion 44A2 is one example of an engaged portion. When the memory cover 44 is attached to the supported projection 92L, the groove portion 44A2 engages with the rib 92L2 and prevents the memory cover 44 from pivoting with respect to the supported projection 92L around the rotation axis C1.

The memory cover 44 is fixed to the side cover 92 by a component, such as a screw 46, being screwed into a screw hole 92L4 of the side cover 92 via the screw hole 44A4. That is, the memory cover 44 is fastened to the supported projection 92L on the same axis the rotation axis C1, via the screw 46 that is one example of a screw member. Thus, when viewed from the axis direction Da, at least a portion of the memory holder unit 45 overlaps with the supported projection 92L of the side cover 92.

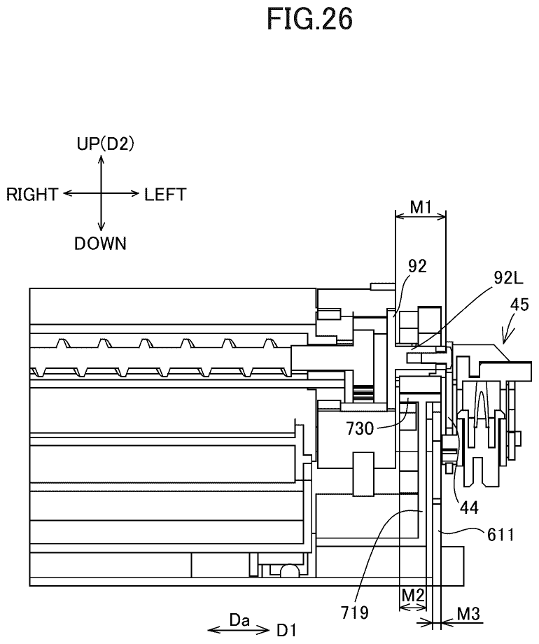

As illustrated in FIG. 26, the length of a clearance, in the axis direction Da, between a side surface of the side cover 92 on the left side in the axis direction Da and a side surface of the memory cover 44 on the right side in the axis direction Da is denoted by M1. In addition, the thickness of a portion of the side holder 719 of the developing unit 7 other than the left support portion 730, in the axis direction Da, is denoted by M2. Furthermore, the thickness of the left side wall 611 of the photosensitive member unit 6 in the axis direction Da is denoted by M3. In this case, M1 is set larger than M2+M3. That is, a portion of the memory cover 44 other than the projection portion 44A3, which is attached to the supported projection 92L, is positioned outside with respect to the cartridge unit 10 in the axis direction Da. In other words, toward a direction extending from the left side to the right side in the axis direction Da, the memory holder unit 45, the left side wall 611, the side holder 719, and the side cover 92 are disposed sequentially in this order. In other words, the memory tag 40 is disposed downstream of the left side wall 611 and the side holder 719 in the first direction D1. In addition, in the present embodiment, the memory holder 41 is positioned on the rotation axis C1 (i.e., a rotation axis), and when viewed from the axis direction Da, at least a portion of the memory holder 41 overlaps with the supported projection 92L.

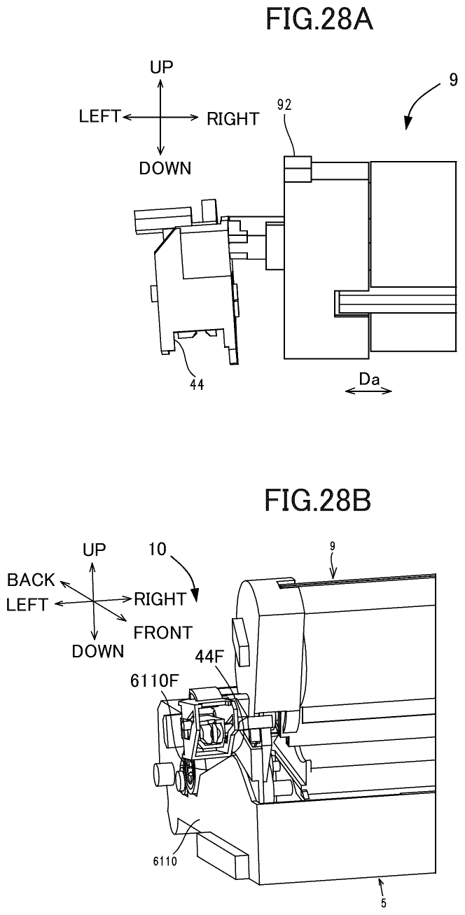

Next, a shape of the left side wall 611 of the frame 610 will be described with reference to FIGS. 27A to 28B. FIG. 27A is a side view in which the cartridge unit 10 is viewed from the left side (i.e., the drive side). FIG. 28A is a front view in which the toner cartridge 9 is viewed from the front side. FIG. 28B is a perspective view in which the cartridge unit 10 is viewed from diagonally above.

As illustrated in FIG. 27A, the left side wall 611 of the frame 610 includes the recess portion 611a. When viewed from the axis direction Da, the recess portion 611a has a shape formed by cutting out a portion of the left side wall 611 that corresponds to the memory cover 44. Thus, when viewed from the axis direction Da, the left side wall 611 does not overlap with the memory holder 41. In the present embodiment, the recess portion 611a has a shape such that the recess portion 611a is opened toward a direction (i.e., the upward direction) in which the toner cartridge 9 attached to the process cartridge 5 is separated from the process cartridge 5. In a state where the toner cartridge 9 is attached to the process cartridge 5, at least a portion of the memory holder 41 is positioned inside the recess portion 611a when viewed from the axis direction Da.

As illustrated in FIG. 28A, the memory cover 44 may incline toward the side cover 92 in the axis direction Da, due to the tolerance or the warpage produced in the molding. As illustrated in FIG. 28B, in a case where the recess portion 611a is not formed and the memory cover 44 inclines as described above, when the toner cartridge 9 is attached to the process cartridge 5, an edge line 44F of a lower edge portion of the memory cover 44 may contact an edge line 6110F of a left side wall 6110. If the edge line 44F of the lower edge portion of the memory cover 44 contacts the edge line 6110F of the left side wall 6110, the toner cartridge 9 may not be smoothly attached to the process cartridge 5, and the workability may deteriorate.

In the present embodiment, however, the recess portion 611a is formed in the left side wall 611 of the frame 610. Thus, even in a case where the memory holder unit 45 inclines, when the toner cartridge 9 is attached to the process cartridge 5, the memory cover 44 is hardly caught by the left side wall 611. As a result, the toner cartridge 9 can be smoothly attached to the process cartridge 5.

### Effects of Present Embodiment

Next, effects of the present embodiment will be described with reference to FIG. 26. FIG. 26 is a cross-sectional view in which a cross section of the cartridge unit 10 taken along a center of the supported projection 92L (i.e., the rotation axis C1)_in the up-and-down direction Dc is viewed from the back side. As illustrated in FIG. 22, the memory holder unit 45 is positioned, separated from a portion of the side cover 92 of the toner cartridge 9 other than the supported projection 92L in the axis direction Da. Thus, the toner cartridge 9 can be attached to the process cartridge 5 without interfering with the process cartridge 5, such that the side holder 719 of the developing unit 7 is held between the side cover 92 and the memory holder unit 45. Thus, when the toner cartridge 9 is attached to the process cartridge 5, the interference between the memory holder unit 45 and a portion of the side holder 719 other than the supported projection 92L, which is an attachment portion for the memory holder unit 45, can be prevented.

As described above, in the present embodiment, a portion of the memory holder unit 45 other than the projection portion 44A3 of the memory cover 44 is positioned outside with respect to the side holder 719 and the left side wall 611 in the axis direction Da. With this arrangement, the need for reducing, more than necessary, the area of the side holder 719 and the left side wall 611 for avoiding the interference with the memory holder unit 45 can be eliminated. As a result, the toner cartridge 9 can be covered by a larger portion of the side holder 719 and a larger portion of the left side wall 611. Thus, the side holder 719 and the left side wall 611 can protect the toner cartridge 9 from any physical contact applied from the outside.

In addition, in the present embodiment, the memory cover 44 is disposed on the side on which the driving portions, such as the developing coupling 710, the developing roller gear 711, the supplying roller gear 712, the first agitator gear 713, and the idle gears 715A and 715B, are disposed in the axis direction Da. Thus, since the side on which the driving portions are disposed can be covered by the side holder 719 and the left side wall 611, the impact on the drive train can be reduced.

In addition, in the present embodiment, the memory holder 41 is positioned on the rotation axis C1. Thus, the amount of pivot movement of the memory holder 41 performed when the toner cartridge 9 is attached to or detached from the process cartridge 5 can be reduced, compared with a case where the memory holder 41 is not positioned on the rotation axis C1. Thus, the need for cutting, more than necessary, the side holder 719 and the left side wall 611 can be eliminated, and the side holder 719 and the left side wall 611 can protect the toner cartridge 9 from any physical contact applied from the outside.

In addition, in the present embodiment, the recess portion 611a is formed in the left side wall 611 of the frame 610. Thus, even in a case where the memory holder unit 45 inclines from the position in design toward the left side wall 611, when the toner cartridge 9 is attached to the process cartridge 5, the memory cover 44 is hardly caught by the left side wall 611. As a result, the toner cartridge 9 can be smoothly attached to the process cartridge 5.

In the present embodiment, as illustrated in FIG. 27A, the description has been made for the case where the recess portion 611a is formed in the left side wall 611. However, the present disclosure is not limited to this. For example, if the memory cover 44 is hardly caught by the left side wall 611 by improving the accuracy of assembling the memory cover 44 to the toner cartridge 9, the recess portion 611a may not be formed, as illustrated by a dot-dot-dash line of FIG. 27A. In this case, since at least a portion of the memory cover 44 and the left side wall 611 can overlap with each other when viewed from the axis direction Da, the toner cartridge 9 and the driving portion can be protected by a larger portion of the left side wall 611.

### Second Embodiment

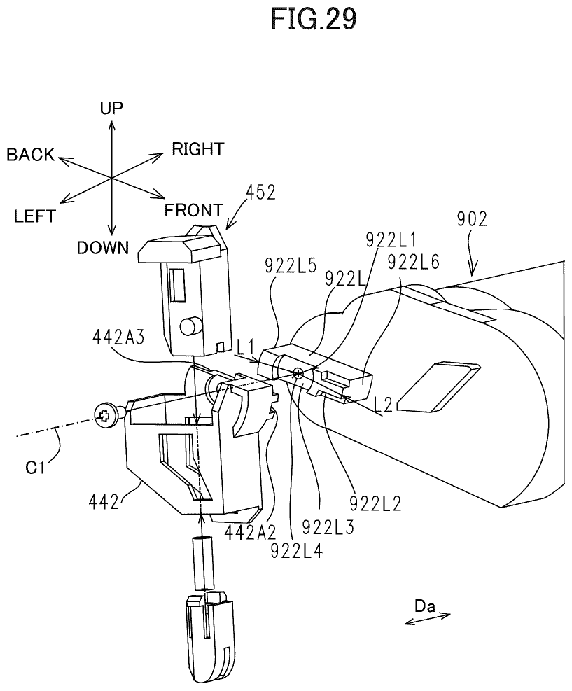

Next, a second embodiment of the present disclosure will be described with reference to FIGS. 29 to 31. In the second embodiment, the shape of the supported projection 92L of the first embodiment is changed. The same components as those of the first embodiment are omitted in the drawings, or described with the same symbols given to the drawings. In the present embodiment, the length from a center of rotation 922L1 of a supported projection 922L to the front-side surface of the supported projection 922L is different from the length from the center of rotation 922L1 to the back-side surface of the supported projection 922L. In this point, the present embodiment differs from the first embodiment in which the length from the center of rotation of the supported projection 92L to the front-side surface of the supported projection 92L is equal to the length from the center of rotation to the back-side surface of the supported projection 92L.

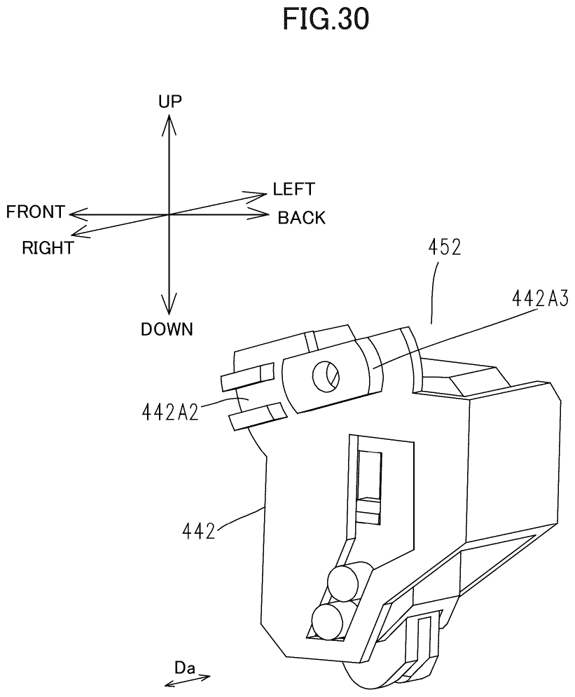

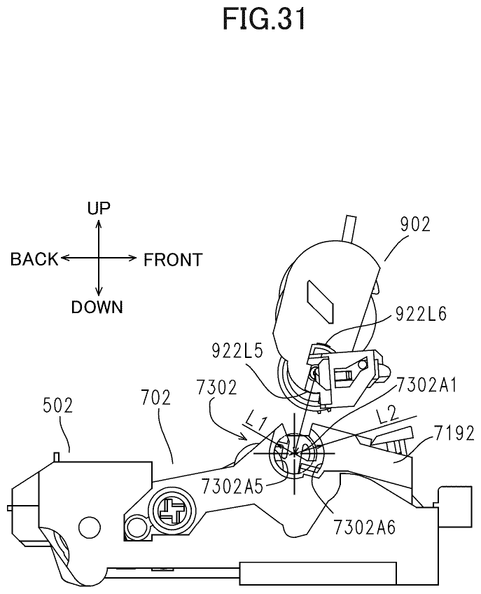

FIG. 29 is an exploded perspective view in which a toner cartridge 902 is viewed diagonally from the upper left. FIG. 30 is a perspective view in which a memory holder unit 452 is viewed from the inside in the axis direction Da. FIG. 31 is a side view in which a state where the toner cartridge 902 is being attached to a process cartridge 502 is viewed from the left side.

As illustrated in FIG. 29, on a side surface of a side cover 922, the supported projection 922L that projects from the side surface toward the left direction in the axis direction Da is disposed. As in the first embodiment, the supported projection 922L is disposed for positioning the toner cartridge 902 to the process cartridge 502. The supported projection 922L includes a recess portion 922L3, a rib 922L2, and a screw hole 922L4. The recess portion 922L3 includes wall portions in the insertion-and-drawing direction Db. The rib 922L2 is formed in front of the recess portion 922L3, and the longitudinal direction of the rib 922L2 is equal to the insertion-and-drawing direction Db. The supported projection 922L includes a back-end surface 922L5 and a front-end surface 922L6 in the insertion-and-drawing direction Db. When viewed from the axis direction Da, each of the back-end surface 922L5 and the front-end surface 922L6 is formed like an arc that is formed around the center of rotation 922L1 performed in the attachment operation.

In the present embodiment, in the supported projection 922L, a first distance L1 that is the radius from the center of rotation 922L1 performed in the attachment operation, to the back-end surface 922L5 is different from a second distance L2 that is the radius from the center of rotation 922L1 to the front-end surface 922L6. In addition, the second distance L2 from the center of rotation 922L1 to the front-end surface 922L6 is longer than the first distance L1 from the center of rotation 922L1 to the back-end surface 922L5. This is because there is not enough space on the back side to elongate the supported projection 922L because the driving-force transmission portion 716 of a developing unit 702 is disposed, and because it is beneficial to increase the strength of the front-side portion of the supported projection 922L because the front-side portion of the supported projection 922L tends to receive larger load in the attachment of the toner cartridge 902.

Thus, in the present embodiment, as illustrated in FIG. 29, the supported projection 922L includes the back-end surface 922L5 that is one example of a first supported portion, and the front-end surface 922L6 that is one example of a second supported portion. The back-end surface 922L5 is disposed at the first distance L1 from the rotation axis C1 in a first intersecting direction (e.g., the back direction) that intersects the axis direction Da. The front-end surface 922L6 is disposed at the second distance L2, longer than the first distance L1, from the rotation axis C1 in the second intersecting direction (e.g., the front direction) that intersects the axis direction Da, and that is different from the first intersecting direction.

As illustrated in FIG. 30, in a memory cover 442, a projection portion 442A3 whose longitudinal direction is equal to the insertion-and-drawing direction Db, and a groove portion 442A2 for preventing the rotation of the memory cover 442 are disposed. The projection portion 442A3 engages with the recess portion 922L3 and the groove portion 442A2 engages with the rib 922L2, so that the memory cover 442 is positioned with respect to the side cover 922. In addition, the memory cover 442 is fixed to the supported projection 922L of the side cover 922 via a component, such as a screw.

As illustrated in FIG. 31, in a side holder 7192 of the developing unit 702, a left support portion 7302 that rotatably supports the supported projection 922L is disposed. Like the supported projection 922L, one radius, in the front-and-back direction, of the left support portion 7302 from a center of rotation 7302A1 performed in the attachment and detachment of the toner cartridge 902 is different from the other radius, in the front-and-back direction, of the left support portion 7302 from the center of rotation 7302A1. The radius from the center of rotation 7302A1 to a surface 7302A5 that the back-end surface 922L5 of the supported projection 922L contacts in the attachment of the toner cartridge 902 is L1, and the radius from the center of rotation 7302A1 to a surface 7302A6 that the front-end surface 922L6 of the supported projection 922L contacts in the attachment of the toner cartridge 9 is L2. Thus, the supported projection 922L of the toner cartridge 902 engages with the left support portion 7302 such that the back-end surface 922L5 of the supported projection 922L of the toner cartridge 902 contacts the surface 7302A5 and the front-end surface 922L6 of the supported projection 922L of the toner cartridge 902 contacts the surface 7302A6, so that the center of rotation of the toner cartridge 902 in the attachment operation is determined.

That is, the left support portion 7302 includes the surface 7302A5 that is one example of a first support portion, and the surface 7302A6 that is one example of a second support portion. The surface 7302A5 guides the back-end surface 922L5 when the toner cartridge 902 moves between the first position and the second position, and positions the back-end surface 922L5 when the toner cartridge 902 is positioned at the second position. The surface 7302A6 guides the front-end surface 922L6 when the toner cartridge 902 moves between the first position and the second position, and positions the front-end surface 922L6 when the toner cartridge 902 is positioned at the second position.

As described above, in the present embodiment, since the front portion of the supported projection 922L is made longer, the mounting strength of the toner cartridge 902 obtained when the toner cartridge 902 is attached to the developing unit 702 can be increased. In addition, since the back portion of the supported projection 922L is made shorter, the interference with the driving-force transmission portion of the developing unit 702 can be avoided, and the upsizing of the apparatus can be suppressed.

### Third Embodiment

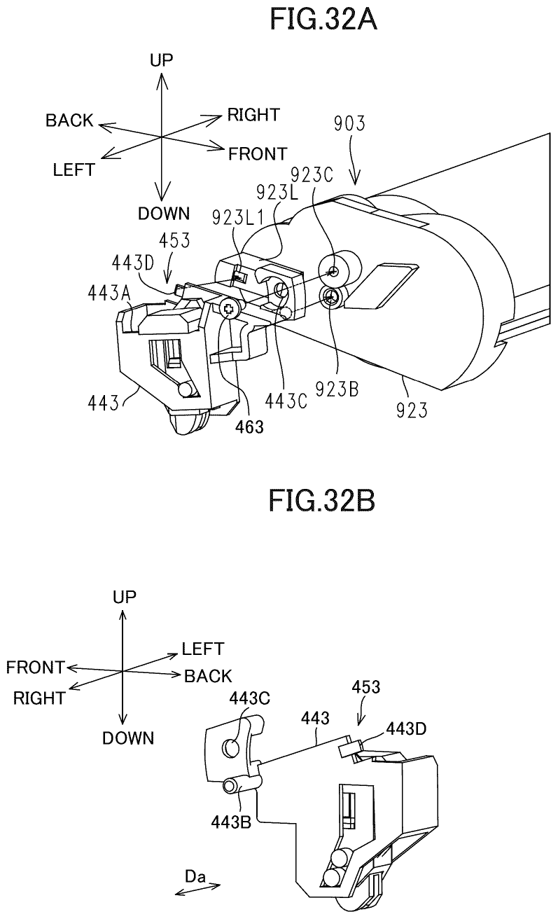

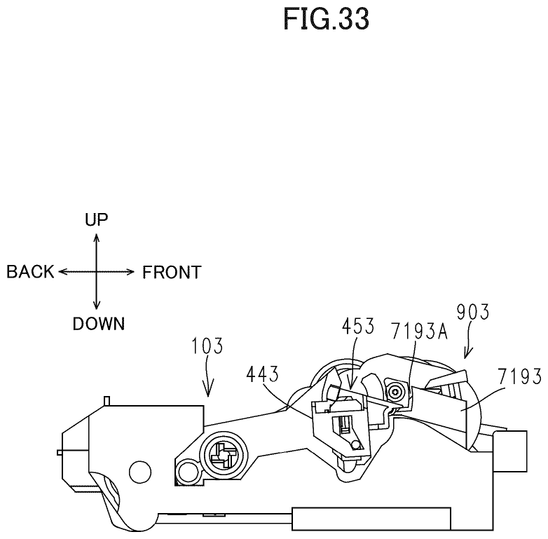

Next, a third embodiment of the present disclosure will be described with reference to FIGS. 32A to 33. In the third embodiment, the configuration of the attachment portion of the memory cover 44 of the first embodiment for attaching the memory cover 44 to the side cover 92 is changed. Thus, the same components as those of the first embodiment are omitted in the drawings, or described with the same symbols given to the drawings.

FIG. 32A is an exploded perspective view in which a toner cartridge 903 is viewed diagonally from the upper left. FIG. 32B is a perspective view in which a memory cover 443 is viewed from the inside in the axis direction Da. FIG. 33 is a side view in which a state where the toner cartridge 903 is being attached to a process cartridge is viewed from the left side.

The present embodiment differs from the first embodiment in the configuration of the attachment portion of the memory cover 443 for attaching the memory cover 443 to a side cover 923. As illustrated in FIGS. 32A and 32B, the memory cover 443 includes a rectangular boss 443D for preventing the rotation, a screw hole 443C, and a boss 443B for positioning the memory cover 443. The rectangular boss 443D is disposed above a holding surface 443A of the memory cover 443. On the other hand, the side cover 923 includes a supported projection 923L that projects toward the left direction, a recess portion 923B that faces the left direction, and a screw hole 923C. In the supported projection 923L, a rectangular hole 923L1 in which the rectangular boss 443D fits is formed. The boss 443B fits in the recess portion 923B. Note that the rectangular hole 923L1 is one example of a first positioning portion, and the recess portion 923B is one example of a second positioning portion.

For attaching the memory cover 443 to the side cover 923, the memory cover 443 is positioned by fitting the rectangular boss 443D of the memory cover 443 in the rectangular hole 923L1 of the side cover 923, and fitting the boss 443B of the memory cover 443 in the recess portion 923B of the side cover 923. That is, the memory cover 443 includes the rectangular boss 443D that is one example of a first positioned portion, and the boss 443B that is one example of a second positioned portion. The rectangular boss 443D engages with the rectangular hole 923L1, and prevents the memory cover 443 from pivoting around a screw member 463. The boss 443B engages with the recess portion 923B, and prevents the memory cover 443 from pivoting around the screw member 463.

In addition, the screw member 463 is fastened to the screw hole 923C of the side cover 923 through the screw hole 443C of the memory cover 443, so that the memory cover 443 is fixed to the side cover 923. Note that the screw hole 923C is disposed above the rotation axis C1 that is an axis of rotation performed in the attachment and detachment of the toner cartridge 903. That is, the memory cover 443 is fastened to the toner cartridge 903 via the screw member 463 at a position downstream of the rotation axis C1 in the second direction D2 (i.e., the upward direction). Thus, as illustrated in FIG. 33, a recess portion 7193A for preventing the interference between the memory cover 443 and a side holder 7193 can be made smaller.

As described above, in the present embodiment, in the configuration for attaching the memory cover 443 to the side cover 923, the rectangular boss 443D and the boss 443B of the memory cover 443 respectively fit in the rectangular hole 923L1 and the recess portion 923B of the side cover 923. That is, the memory cover 443 is fixed to the side surface of the side cover 923 via not only the supported projection 923L of the side cover 923, but also the screw member. In this manner, positioning of the memory cover 443 and preventing the memory cover 443 from rotating are performed at two positions, mainly including the position of the screw hole 923C. Thus, the firmer attachment of the memory cover 443 can be achieved in the configuration for attaching the memory cover 443.

In addition, in the present embodiment, the attachment position of the memory cover 443 is set above the rotation axis C1 that is an axis of rotation performed in the attachment and detachment of the toner cartridge 903. Thus, the recess portion 7193A for preventing the interference between the memory cover 443 and the side holder 7193 can be made smaller. As a result, the deterioration in strength of the side holder 7193 can be reduced.

### Fourth Embodiment

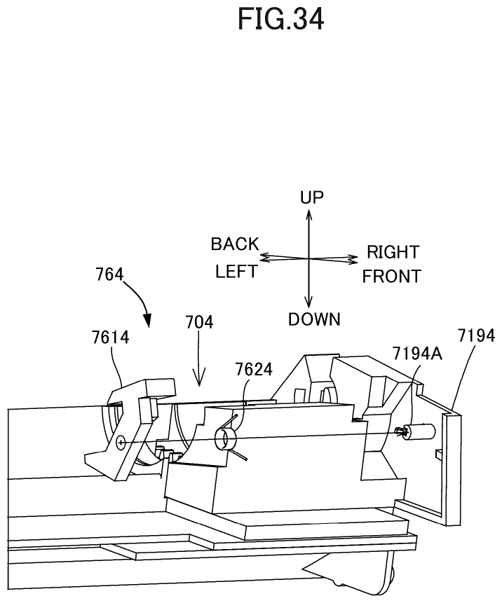

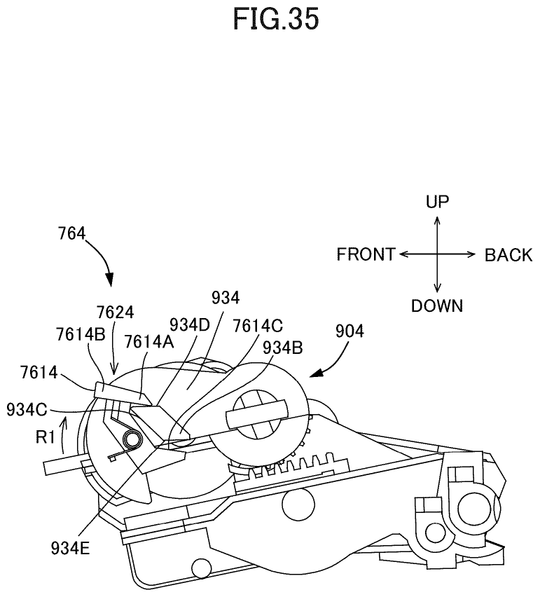

Next, a fourth embodiment of the present disclosure will be described with reference to FIGS. 34 and 35. FIG. 34 is a perspective view in which a developing unit 704 is viewed diagonally from the upper left for describing the assembly of the developing unit 704. FIG. 35 is a cross-sectional view of a lift mechanism 764 and its surroundings, taken along a plane perpendicular to the right-and-left direction. In the fourth embodiment, the position of the lift mechanism 760 of the first embodiment is changed from the left side to the right side. Since the operation of the lift mechanism 764 of the present embodiment is the same as that in the first embodiment described with reference to FIGS. 20A to 20C and FIGS. 21A to 21C, the detailed description thereof will be omitted. Thus, the same components as those of the first embodiment are omitted in the drawings, or described with the same symbols given to the drawings.

As illustrated in FIG. 35, a projection portion 934B is disposed on a side cover 934 of a toner cartridge 904 on the right side. The projection portion 934B is one example of a locked portion, and includes an abutment surface 934C, a holding surface 934D, and a receiving surface 934E. In addition, as illustrated in FIG. 34, the lift mechanism 764 includes a boss 7194A disposed on a side holder 7194 of the developing unit 704, a lift member 7614, and a torsion coil spring 7624. The lift member 7614 and the torsion coil spring 7624 are attached to the boss 7194A, and can pivot around the boss 7194A. The lift member 7614 is one example of a lock lever, and includes an abutment portion 7614A, an operation portion 7614B, and a lifting portion 7614C. In addition, the lift member 7614 is urged toward a direction indicated by an arrow R1, by the torsion coil spring 7624. In the present embodiment, the projection portion 934B and the lift member 7614 are disposed upstream of the toner cartridge 904 in the first direction D1 (i.e., the left direction).

As described above, in the present embodiment, the lift mechanism 764 is disposed on the right side of the toner cartridge 904. Thus, the flexibility in design can be increased in the arrangement of the lift mechanism.

Note that in the above-described embodiments, the process cartridge 5 that is one example of a first unit is a cartridge formed by attaching the developing unit 7 to the photosensitive member unit 6. However, the present disclosure is not limited to this. For example, the process cartridge used may be a cartridge into which the photosensitive member unit 6 and the developing unit 7 are integrated with each other such that the photosensitive drum and the developing roller cannot be separated from each other.

In each of the above-described disclosures, the memory can be disposed on the side on which the driving-force transmission portion for the developing roller is disposed, without upsizing the apparatus.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-224569, filed Dec. 19, 2024 which is hereby incorporated by reference herein in its entirety.

What is claimed is:

1. A cartridge unit configured to be detachably attached to an apparatus body of an image forming apparatus, the cartridge unit comprising:
a first unit including
a photosensitive drum configured to bear a developer image,
a frame rotatably supporting the photosensitive drum,
a developing roller configured to develop an electrostatic latent image formed on a surface of the photosensitive drum, and including a first end in an axis direction and a second end opposite to the first end in the axis direction, and
a driving-force transmission portion disposed on a side of the first end of the developing roller and configured to transmit driving force transmitted from the image forming apparatus, to the developing roller; and
a second unit including a memory disposed on the side of the first end configured to store information, and a holder holding the memory, the second unit being detachably attached to the first unit and configured to accommodate developer,
wherein the frame includes
a bottom surface that extends in the axis direction, and
a first side wall that extends from the bottom surface in an intersecting direction that intersects the axis direction, and that is positioned, in the axis direction, inside with respect to the driving-force transmission portion and outside with respect to the second unit attached to the first unit, and
wherein the memory is disposed outside with respect to the first side wall in the axis direction in a state where the second unit is attached to the first unit.

2. The cartridge unit according to claim 1, wherein the first unit includes
a drum unit that includes the photosensitive drum and the frame, and
a developing unit that includes the developing roller and the driving-force transmission portion, and that is detachably attached to the drum unit, and
wherein the first side wall of the frame includes a unit positioning portion configured to position the developing unit with respect to the drum unit.

3. The cartridge unit according to claim 2,
wherein the developing unit includes a second side wall that extends in the intersecting direction, and that is positioned outside with respect to the driving-force transmission portion in the axis direction in the state where the second unit is attached to the first unit, and
wherein the memory is disposed outside with respect to the second side wall in the axis direction.

4. The cartridge unit according to claim 1,
wherein the second unit includes a developer discharge port configured to discharge developer to an outside of the second unit,
wherein the first unit includes a developer receive port configured to receive developer discharged from the developer discharge port of the second unit,
wherein the second unit is configured to move with respect to the first unit between a first position and a second position, the first position being a position at which the developer receive port and the developer discharge port do not communicate with each other, the second position being a position to which the second unit rotates around a rotation axis from the first position and at which the developer receive port and the developer discharge port communicate with each other, and
wherein the holder is positioned on the rotation axis.

5. The cartridge unit according to claim 4,
wherein the first unit includes a rotation support portion configured to rotatably support the second unit in a case where the second unit moves between the first position and the second position,
wherein the second unit includes a rotation supported portion configured to be rotatably supported by the rotation support portion, and
wherein when viewed from the axis direction, at least a portion of the holder overlaps with the rotation supported portion.

6. The cartridge unit according to claim 5,
wherein the rotation supported portion includes
a first supported portion disposed at a first distance from the rotation axis in a first intersecting direction that intersects the axis direction, and
a second supported portion disposed at the first distance from the rotation axis in a second intersecting direction that intersects the axis direction and that is different from the first intersecting direction, and
wherein the rotation support portion includes
a first support portion configured to guide the first supported portion in the case where the second unit moves between the first position and the second position, and position the first supported portion in a case where the second unit is positioned at the second position, and
a second support portion configured to guide the second supported portion in the case where the second unit moves between the first position and the second position, and position the second supported portion in the case where the second unit is positioned at the second position.

7. The cartridge unit according to claim 5,
wherein the rotation supported portion includes
a first supported portion disposed at a first distance from the rotation axis in a first intersecting direction that intersects the axis direction and extends toward the driving-force transmission portion, and
a second supported portion disposed at a second distance longer than the first distance from the rotation axis in a second intersecting direction that intersects the axis direction and that is different from the first intersecting direction, and
wherein the rotation support portion includes
a first support portion configured to guide the first supported portion in the case where the second unit moves between the first position and the second position, and position the first supported portion in a case where the second unit is positioned at the second position, and
a second support portion configured to guide the second supported portion in the case where the second unit moves between the first position and the second position, and position the second supported portion in the case where the second unit is positioned at the second position.

8. The cartridge unit according to claim 1, wherein the second unit includes a support member supporting the holder such that the holder is allowed to move with respect to the second unit in a direction that intersects the axis direction.

9. The cartridge unit according to claim 6,
wherein the second unit includes a support member supporting the holder such that the holder is allowed to move with respect to the second unit in a direction that intersects the axis direction, and
wherein the support member is attached to the rotation supported portion.

10. The cartridge unit according to claim 9,
wherein the support member is fastened to the rotation supported portion via a screw member on the same axis as the rotation axis,
wherein the second supported portion includes an engaging portion, and
wherein the support member includes an engaged portion configured to engage with the engaging portion and prevent the support member from pivoting around the rotation axis with respect to the rotation supported portion in a case where the support member is attached to the rotation supported portion.

11. The cartridge unit according to claim 9,
wherein the rotation supported portion includes a first positioning portion,
wherein the second unit includes a second positioning portion,
wherein the support member is configured to be fastened to the second unit via a screw member at a position downstream of the rotation axis in the intersecting direction, and
wherein the support member includes
a first positioned portion configured to engage with the first positioning portion and prevent the support member from pivoting around the screw member, and
a second positioned portion configured to engage with the second positioning portion and prevent the support member from pivoting around the screw member.

12. The cartridge unit according to claim 1,
wherein the first unit includes a lock lever,
wherein the second unit includes a locked portion configured to be locked by the lock lever in a case where the second unit is attached to the first unit,
wherein the locked portion and the lock lever are disposed on the side of the first end and outside with respect to the second unit in the axis direction, and
wherein the memory is disposed outside with respect to the locked portion and the lock lever in the axis direction.

13. The cartridge unit according to claim 1,
wherein the first unit includes a lock lever,
wherein the second unit includes a locked portion configured to be locked by the lock lever in a case where the second unit is attached to the first unit, and
wherein the locked portion and the lock lever are disposed on a side of the second end and outside with respect to the second unit in the axis direction.

14. The cartridge unit according to claim 1, wherein the first side wall does not overlap with the holder when viewed from the axis direction.

15. The cartridge unit according to claim 14,
wherein the first side wall includes a recess portion such that the recess portion is opened toward a direction in which the second unit attached to the first unit is separated from the first unit, and
wherein in the state where the second unit is attached to the first unit, at least a portion of the holder is positioned inside the recess portion when viewed from the axis direction.

16. The cartridge unit according to claim 1, wherein the first side wall overlaps with at least a portion of the holder when viewed from the axis direction.

17. An image forming apparatus comprising:
the cartridge unit according to claim 1 and attached to the apparatus body; and
a fixing apparatus configured to fix a developer image formed on a recording material to the recording material.
